(19) United States
(12) Patent Application Publication
(10) Pub. No.: US 2015/0288319 A1
(43) Pub. Date: Oct. 8, 2015

(54) PORTABLE, SOLAR ENERGY GENERATION ASSEMBLY

(71) Applicant: Togo Solar, Inc., Saratoga, CA (US)

(72) Inventors: Albert Hartman, Palo Alto, CA (US); Laizhong Luo, Saratoga, CA (US)

(21) Appl. No.: 14/680,922

(22) Filed: Apr. 7, 2015

Related U.S. Application Data
(60) Provisional application No. 61/976,772, filed on Apr. 8, 2014.

(51) Int. Cl. H02S 10/40; H02S 30/20; H02S 40/36; H02S 20/30

(52) U.S. Cl. CPC H02S 10/40; H02S 20/30; H02S 30/20; H02S 40/36

(57) ABSTRACT

A solar panel assembly is selectively positionable by a user to collect solar rays from a sun. The solar panel assembly comprises a first solar panel, a second solar panel, and a flexible, first connector. The first solar panel and the second solar panel are configured to collect solar rays from the sun. Additionally, the first connector mechanically and electrically connects the first solar panel to the second solar panel so that the first solar panel and the second solar panel are selectively movable between an open configuration where the solar panels are positioned substantially side-by-side in a planar array and a closed configuration where the solar panels are stacked substantially on top of one another. The first connector can include a perforated metal conductor that is coupled to and extends between the first solar panel and the second solar panel.

### RELATED APPLICATION

This application is related to and claims priority on U.S. Provisional Application Ser. No. 61/976,772 filed on Apr. 8, 2014, and entitled “PORTABLE SOLAR PANEL ENERGY SYSTEM”. To the extent permissible, the contents of U.S. Provisional Application Ser. No. 61/976,772 are incorporated herein by reference.

### BACKGROUND

As portable electronic devices become smaller and more capable, many users have begun carrying their devices with them and relying on their use throughout the day. With heavy usage, it has become more and more frequent that these devices run out of power before the end of the day, thereby causing great inconvenience for the user. It has therefore become necessary for the devices to find power sources in the field so that they can be recharged. One popular choice is for users to carry an external pre-charged battery pack that can supply power to recharge their portable electronic devices. These battery packs are typically small and portable enough that they can charge the devices while the user is carrying them. Utilizing such external battery packs has proved useful in supplying the necessary power to portable electronic devices in order to maintain the devices in full operation throughout the entire day. Unfortunately, the external battery packs will eventually run out of power themselves, and have to be recharged. Thus, it is desired to find a convenient source of energy for the user to utilize for purposes of recharging their portable electronic devices and/or their external battery packs when the user is on the go.

An increasingly popular choice is to make use of solar energy, which has the advantages of being more ecologically friendly than burned carbon-generated electricity, as well as being conveniently available even when far away from any built structures with wall power plugs. The challenge is for mobile solar power sources to be convenient for users to utilize. Unfortunately, to date, mobile solar power sources have suffered from certain drawbacks. For example, large solar panels can require minimum time in the sun, but they are bulky and heavy to carry all day. Conversely, small portable solar chargers are easy to carry, but fail to produce enough electricity to fully recharge user's devices, even after several inconvenient hours in the sun.

### SUMMARY

The present invention is directed toward a solar panel assembly that is selectively positionable by a user to collect solar rays from a sun. In various embodiments, the solar panel assembly comprises a first solar panel, a second solar panel, and a flexible first connector. The first solar panel is configured to collect solar rays from the sun. Additionally, the second solar panel is also configured to collect solar rays from the sun. Further, the first connector mechanically and electrically connects the first solar panel to the second solar panel so that the first solar panel and the second solar panel are selectively movable between an open configuration where the solar panels are positioned substantially side-by-side in a planar array and a closed configuration where the solar panels are stacked substantially on top of one another. In certain embodiments, the first connector includes a perforated metal conductor that is coupled to and extends between the first solar panel and the second solar panel.

In some such embodiments, the first connector includes a perforated copper mesh that is coupled to and extends between the first solar panel and the second solar panel.

The solar panel assembly can further comprise a third solar panel that is configured to collect solar rays from the sun; and a flexible, second connector that mechanically and electrically connects the second solar panel to the third solar panel. Additionally, the second connector can include a perforated metal conductor that is coupled to and extends between the second solar panel and the third solar panel. Further, in some embodiments, the solar panel assembly further comprises a fourth solar panel that is configured to collect solar rays from the sun; and a flexible, third connector that mechanically and electrically connects the third solar panel to the fourth solar panel. The third connector can also include a perforated metal conductor that is coupled to and extends between the third solar panel and the fourth solar panel.

The present invention is further directed toward a solar energy generation assembly including the solar panel assembly as described above, and a support assembly that supports the solar panel assembly during the collection of solar rays from the sun. In various embodiments, the support assembly includes a base and a cover that is adjustably coupled to the base.

In some such embodiments, the solar energy generation assembly further comprises a positioning assembly that is configured to assist the user in accurately pointing the solar panel assembly toward the sun. The positioning assembly can include a signal-generating member that generates a signal based at least in part on the position of the sun relative to the signal-generating member. In certain embodiments, the positioning assembly can further include a signal-receiving member, wherein the signal impinging on the signal-receiving member indicates that the solar panel assembly is accurately pointed toward the sun.

In some embodiments, the support assembly is selectively movable between a storage configuration, wherein the solar panel assembly can be positioned substantially within the support assembly, and an operational configuration, wherein an angle of the cover relative to the base can be selectively adjusted to be between approximately zero and ninety degrees. The support assembly can further include a support arm that is movably coupled to the cover. The support arm can be removably coupled to the solar panel assembly with a coupler assembly when the support assembly is in the operational configuration. In some embodiments, the coupler assembly includes a first coupler member that is secured to the support arm and a second coupler member that is secured to a back surface of the solar panel assembly. The coupler members are configured to selectively engage one another to removably couple the solar panel assembly to the cover. In one such embodiment, the first coupler member is a magnetic disc and the second coupler member is a magnetic washer that selectively engages the magnetic disc.

In certain embodiments, the solar energy generation assembly further comprises a control assembly that controls the conversion of the solar rays that have been collected by the solar panel assembly into solar energy, and further controls the use of the solar energy to provide power to a remote device. Moreover, in some such embodiments, the control assembly further provides a first status update to the user relating to the conversion of the solar rays into solar energy, and a second status update to the user relating to the use of the solar energy to provide power to the remote device.

Additionally, the present invention is also directed toward a solar energy generation assembly that is selectively positionable by a user relative to a sun to collect solar rays from the sun and generate solar energy from the solar rays, the solar energy generation assembly comprising (i) a solar panel assembly that is configured to collect solar rays from the sun; (ii) a support assembly that supports the solar panel assembly during the collection of solar rays from the sun; and (iii) a positioning assembly that is configured to assist the user in accurately pointing the solar panel assembly toward the sun, the positioning assembly including a signal-generating member that generates a signal based at least in part on the position of the sun relative to the signal-generating member.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a rear perspective view of an embodiment of a portable, solar energy generation assembly having features of the present invention, the solar energy generation assembly including a solar panel assembly that is in an open (unfolded) configuration and a support and storage assembly that is in an operational configuration;

FIG. 1B is a front perspective view of the solar energy generation assembly illustrated in FIG. 1A;

FIG. 2A is a simplified schematic illustration of an embodiment of the solar panel assembly usable as part of the solar energy generation assembly illustrated in FIG. 1A, the solar panel assembly being in the open (unfolded) configuration;

FIG. 2B is a simplified schematic illustration of the solar panel assembly illustrated in FIG. 2A, with the solar panel assembly being in a closed (folded) configuration;

FIG. 3A is a simplified schematic illustration of another embodiment of the solar panel assembly illustrated in FIG. 1A, the solar panel assembly being in the open (unfolded) configuration;

FIG. 3B is a simplified schematic illustration of the solar panel assembly illustrated in FIG. 3A, with the solar panel assembly being in the closed (folded) configuration;

FIG. 4A is a simplified schematic illustration of still another embodiment of the solar panel assembly illustrated in FIG. 1A, the solar panel assembly being in the open (unfolded) configuration;

FIG. 4B is a simplified schematic illustration of the solar panel assembly illustrated in FIG. 4A, with the solar panel assembly being in the closed (folded) configuration;

FIG. 5A is a top exploded perspective view of a solar panel assembly usable as part of the solar energy generation assembly illustrated in FIG. 1A;

FIG. 5B is a bottom exploded perspective view of the solar panel assembly illustrated in FIG. 5A;

FIG. 5C is an enlarged view of a portion of the solar panel assembly illustrated in FIG. 5A;

FIG. 6A is a perspective view of another embodiment of the solar energy generation assembly having features of the present invention, the solar energy generation assembly including another embodiment of the solar panel assembly being in the open configuration, and another embodiment of the support and storage assembly being in an operational configuration;

FIG. 6B is perspective view of a portion of the solar energy generation assembly illustrated in FIG. 6A, the support and storage assembly being in the operational configuration;

FIG. 6C is a perspective view of the solar energy generation assembly illustrated in FIG. 6A, the solar panel assembly being in the closed configuration;

FIG. 6D is a perspective view of the solar energy generation assembly illustrated in FIG. 6A, the support and storage assembly being in the storage configuration;

FIG. 7A is a perspective view of an embodiment of the support and storage assembly usable as part of the solar energy generation assembly illustrated in FIG. 1A;

FIG. 7B is an enlarged view of a portion of the support and storage assembly as indicated by dashed circle B-B in FIG. 7A;

FIG. 8A is a perspective view of another embodiment of the support and storage assembly usable as part of the solar energy generation assembly illustrated in FIG. 1A;

FIG. 8B is another perspective view of the support and storage assembly illustrated in FIG. 8A;

FIG. 8C is an enlarged view of a portion of the support and storage assembly as indicated by dashed circle C-C in FIG. 8A;

FIG. 9A is a perspective view of still another embodiment of a support and storage assembly usable as part of the solar energy generation assembly illustrated in FIG. 1A;

FIG. 9B is an enlarged view of a portion of the support and storage assembly as indicated by dashed circle B-B in FIG. 9A;

FIG. 10 is a block diagram of an embodiment of a control assembly that is usable as part of the solar energy generation assembly illustrated in FIG. 1A; and

FIGS. 11A-11D illustrate screen grabs for potential applications that can be run on a remote device usable with the solar energy generation assembly illustrated in FIG. 1A.

### DESCRIPTION

Reference will now be made in detail to embodiments which are illustrated in the accompanying drawings. In the following detailed descriptions, numerous specific details are set forth in order to provide a thorough understanding of the present invention. However it will be apparent to one of ordinary skill in the art that the invention may be practiced without these specific details. In other instances, use of well-known methods, procedures, components, circuits, and networks will not be described in detail in order to not obscure aspects of the embodiments.

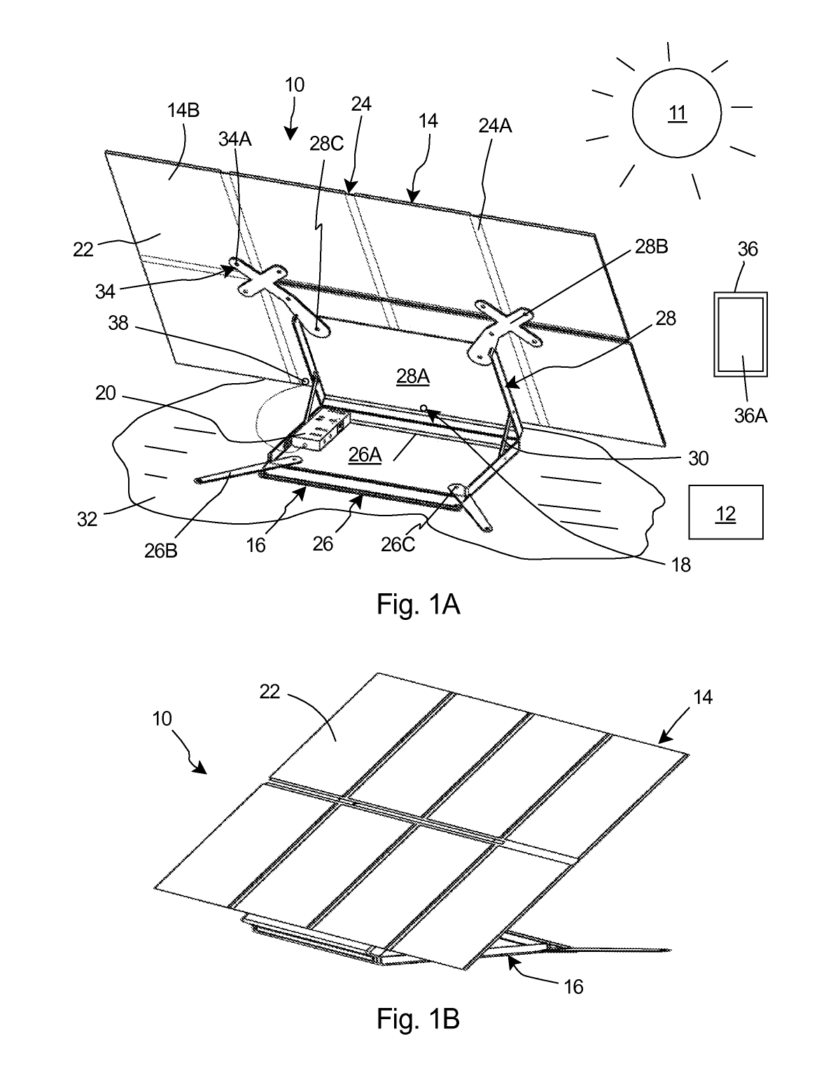

FIG. 1A is a rear perspective view of a portable, solar energy generation assembly 10 (also referred to herein simply as a “generation assembly”) having features of the present invention. As described in detail herein, the generation assembly 10 is configured to collect rays from the sun 11, and to convert the sun's rays to energy that can be utilized to provide power to one or more portable devices 12 (illustrated as a box), e.g., portable electronic devices such as a smart phone, a tablet, a laptop computer, an external battery pack, etc.

The design of the generation assembly 10 can be varied to suit the specific requirements of the user of the generation assembly 10. In various embodiments, as illustrated in FIG. 1A, the generation assembly 10 includes a solar panel assembly 14, a support and storage assembly 16 (also referred to herein as a “support assembly”), a positioning assembly 18, and a control assembly 20. During operation of the generation assembly 10, the support assembly 16 is configured to support and retain the solar panel assembly 14, with the solar panel assembly 14 being properly oriented toward the sun 11 for efficient collection of solar rays. Alternatively, the generation assembly 10 can be designed to include more components or fewer components than those specific illustrated and described in relation to FIG. 1A. For example, in one non-exclusive alternative embodiment, the generation assembly 10 can be designed without the positioning assembly 18.

As an overview, the generation assembly 10 is configured to provide improved and more efficient energy generation capabilities in a small, lightweight, and easily portable package. Additionally, the generation assembly 10 is relatively simple and convenient to use, and effectively capable of producing a sufficient amount of solar-generated energy to conveniently and fully recharge the user's portable devices 12, while minimizing the amount of time spent in the sun harvesting solar energy. Further, the generation assembly 10 also enables the user to conveniently monitor the progress of the energy collection and generation process, as well as the status of any charging and/or recharging of the user's portable devices 12.

The design of the solar panel assembly 14 can be varied depending on the specific requirements of the generation assembly 10. For example, the size, and thus the energy generation capabilities, of the solar panel assembly 14 can be varied depending on how much energy is generally required to recharge the portable device(s) 12 of the user. As shown in FIG. 1A, the solar panel assembly 14 can include a plurality of individual solar panels 22 that are movably coupled to one another. Additionally, as described herein, the solar panel assembly 14 and/or the solar panels 22 are movable relative to one another between an open (unfolded) configuration, in which the solar panels 22 can be positioned in a substantially flat, planar array in order to collect solar rays from the sun 11 for purposes of solar energy generation, and a closed (folded) configuration, in which the solar panels 22 can be conveniently and compactly put away for storage.

In the specific embodiment illustrated in FIG. 1A, the solar panel assembly 14 includes eight solar panels 22 that are movably connected to one another to form a substantially flat, four-by-two panel array when the solar panels 22 are in the open configuration. Alternatively, the solar panel assembly 14 can include greater than eight solar panels 22 or fewer than eight solar panels 22, and/or the solar panels 22 can be positioned in a different manner relative to one another when the solar panels 22 are in the open configuration.

Additionally, as illustrated, the solar panel assembly 14 further includes a connector assembly 24 that flexibly and movably connects the solar panels 22 together. More specifically, in some embodiments, the connector assembly 24 can be designed and positioned such that each of the solar panels 22 is movably and directly connected to at least one, but no more than two, of the other solar panels 22. As described herein, the connector assembly 24 can include a plurality of connectors 24A, e.g., hinges, that are lightweight and flexible, but still sturdy enough that the solar panels 22 remain connected together, e.g., electrically and mechanically, through repeated movements between the open configuration and the closed configuration.

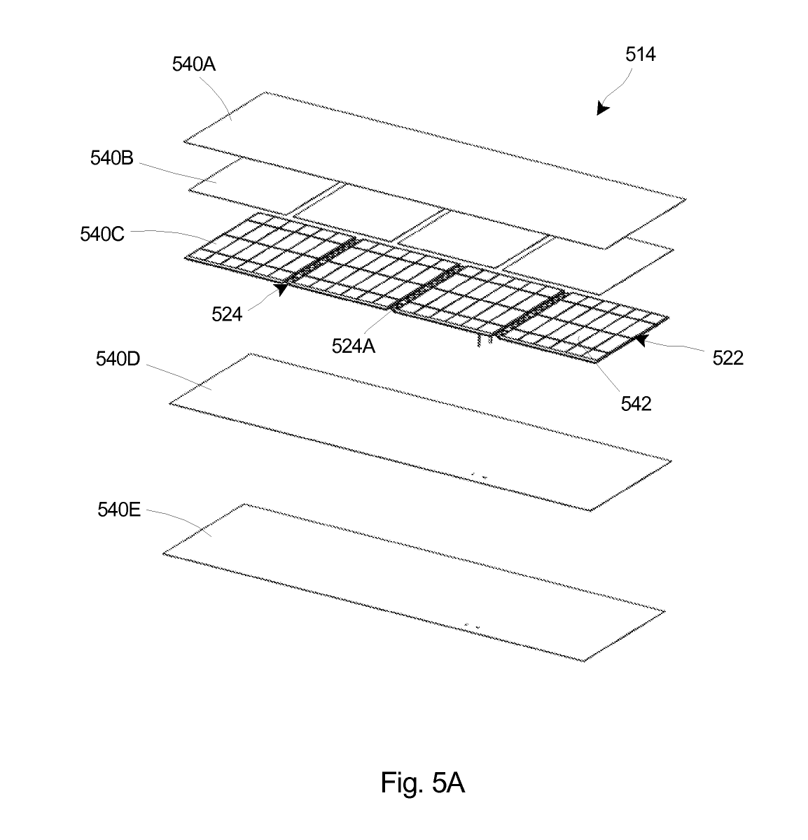

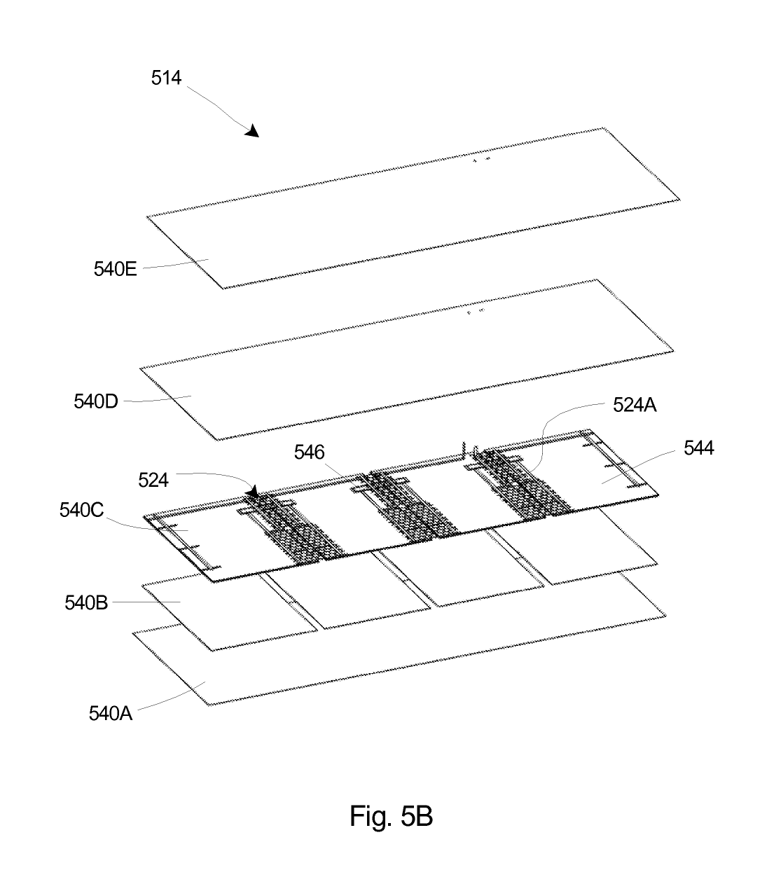

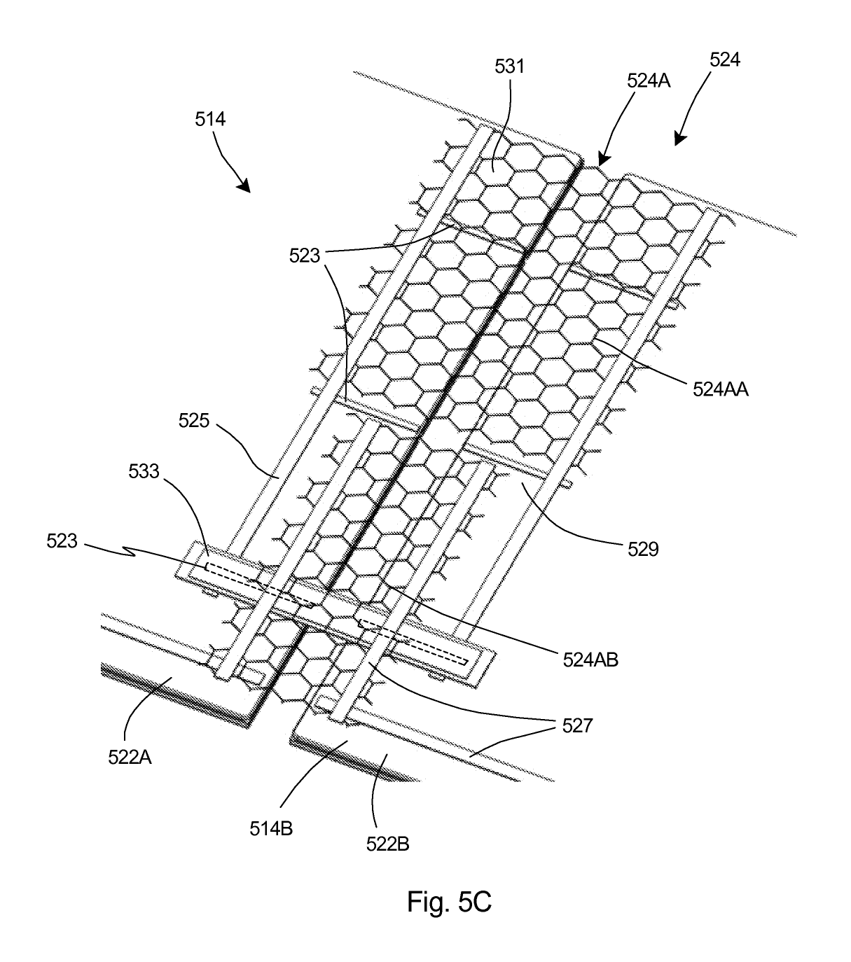

In certain embodiments, each of the connectors 24A can be formed at least in part from a perforated metal conductor. For example, in one such, non-exclusive embodiment, the connectors 24A can be formed at least in part from a perforated copper mesh material. Additionally and/or alternatively, the connectors 24A can include one or more of aluminum, brass, nickel, gold, bronze, platinum, silver, steel, stainless steel, titanium and zinc. With this design, the solar panels 22 can be effectively mechanically and electrically connected to one another. This construction yields a thin, very flexible and very durable electrical connection that is superior to conventional interconnects, which typically utilize stranded wire interconnects or thin tabs as hinges that can experience high bending stresses and high stiffness. By spreading the electrical current across a wider width and perforating the conductors, a thinner metal can be used. The metal elements that are present undergo twist as well as bending when the solar panels 22 are folded. The result is a more flexible connector 24A that resists cracking due to repeated bending and can permit sharp folding radii. Alternatively, the connectors 24A can have another suitable design and/or can be formed from other suitable materials. One non-exclusive alternative embodiment of the connectors 24A will be illustrated and described herein below in FIG. 5C.

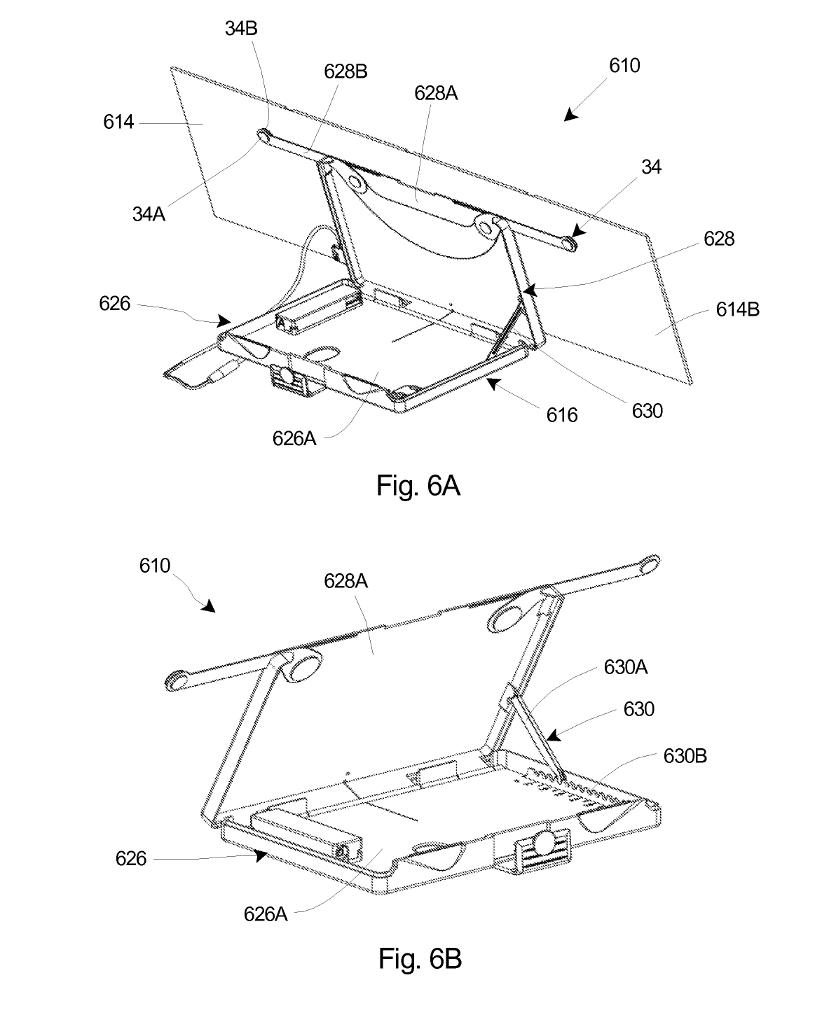

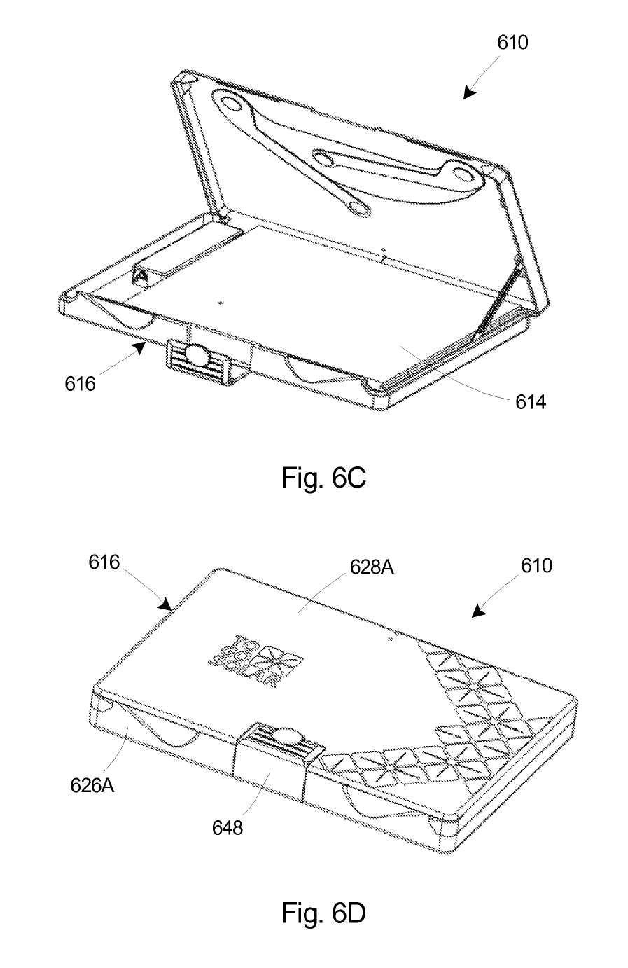

The support assembly 16 is configured to support the solar panel assembly 14 during use. More specifically, as shown, the solar panel assembly 14 can be effectively and securely mounted on the support assembly 16 during the process of collecting solar rays from the sun 11. The design of the support assembly 16 can be varied to suit the specific requirements of the generation assembly 10 and/or the solar panel assembly 14. In certain embodiments, as illustrated, the support assembly 16 can be a substantially rectangular, rigid case having a base assembly 26 and a cover assembly 28 that is movably, e.g., hingedly, coupled to the base assembly 26. As described herein, the support assembly 16 can be selectively moved between a storage (closed) configuration (e.g., as shown in FIG. 6D), when the solar panel assembly 14 is not being used to collect solar rays, and an operational (open) configuration (e.g., as shown in FIG. 1A), when the solar panel assembly 14 is being used to collect solar rays. More specifically, in various embodiments, the support assembly 16 includes an adjuster assembly 30 that enables the position (e.g. angle) of the cover assembly 28 to be selectively and stably adjusted relative to the base assembly 26 between the storage configuration and the operational configuration.

As illustrated in this embodiment, the base assembly 26 includes a base 26A that forms a bottom or base member of the rigid case 16, and a stabilization assembly 26B that is movably coupled to the base 26A. During use, the base 26A is configured to be positioned on a support surface 32, e.g., the ground, a floor, a table, etc. Additionally, during use, the stabilization assembly 26B, e.g., one or more stabilizer arms, can be positioned to extend away from the base 26A so as to provide additional stabilizing support for the solar panel assembly 14 that, as shown, can be mounted on the support assembly 16. Conversely, when the generation assembly 10 is not in use, the stabilization assembly 26B can be collapsed so as to be positioned substantially within the rigid case 16.

In one embodiment, the stabilizer arms 26B can each have a single pivoting attachment 26C to the base 26A that allows the stabilizer arms 26B to be quickly and easily moved between the extended position where they can engage the support surface 32 and the collapsed position where they are positioned within the perimeter of the base assembly 26. Additionally and/or alternatively, the stabilizer arms 26B can be constructed of two or more pivotally attached segments, which can provide further compactness.

The stabilization assembly 26B, e.g., the stabilizer arms, can be made of a thin, strong material like steel, aluminum or plastic, as non-exclusive examples. The stabilizer arms 26B can also be formed so a stiffening ridge is created, thus enabling the use of thinner lightweight material gauges. Further, an interleaver structure can be utilized which forms a stiff mounting surface for the stabilizer arms 26B onto the base 26A. With this design, a more rigid structure can be formed for the stabilizer arms 26B.

As noted above, the cover assembly 28 is configured to be selectively moved and/or adjusted relative to the base assembly 26 such that the support assembly 16 can be selectively moved between the storage configuration and the operational configuration. As described in greater detail herein below, it should be appreciated that the operational configuration can comprise myriad different elevational positions (angles) for the cover assembly 28 relative to the base assembly 26 depending on the position of the sun 11 relative to the generation assembly 10. More specifically, the orientation and elevation of the support assembly 16 can be selectively adjusted to enable the most efficient solar ray collection and energy generation.

The design of the cover assembly 28 can be varied to suit the requirements of the generation assembly 10. As illustrated, in some embodiments, the cover assembly 28 can include a cover 28A that is movably and/or adjustably coupled to the base 26A, e.g., through the use of the adjuster assembly 30, the cover 28A forming a top member of the rigid case 16, and one or more support arms 28B that are movably coupled to the cover 28A. As shown, when the support assembly 16 is in the operational configuration, the cover 28A can be positioned at any desired angle relative to the base 26A, e.g., between approximately zero and ninety degrees relative to the base 26A. Additionally, the specific angle of the cover 28A relative to the base 26A can be selectively adjusted with the adjuster assembly 30 to enable the most efficient collection of solar energy from the sun 11. Further, during use of the generation assembly 10, in order to provide better and broader support for the solar panel assembly 14, the support arms 28B can be positioned to extend away from the cover 28A. Conversely, as with the stabilization assembly 26B, when the generation assembly 10 is not in use, the support arms 28B can be moved, e.g., collapsed, relative to the cover 28A so as to be positioned substantially within the rigid case 16. As a non-exclusive example, the support arms 28B can each be attached with a pivot 28C to the cover 28A.

It should be appreciated that the use of the support arms 28B enables the use more flexible solar panel connectors 24, which further enables a more compact, lightweight and convenient design when the generation assembly 10 is not in use.

The support arms 28B can have any suitable design. Moreover, the design of the support arms 28B can be varied to suit the specific requirements of the generation assembly, the solar panel assembly 14 and/or the support assembly 16. For example, in the specific embodiment illustrated in FIG. 1A, the support arms 28B are somewhat T-shaped and have the single pivoting attachment 28C to the cover 28A. Alternatively, the support arms 28B can be substantially straight or slightly curved in shape, and/or can have another suitable shape. Still alternatively, the support arms 28B can include telescoping collapsible structures, supporting arms sliding out in parallel to the cover 28A from recessed storage locations on the cover 28A, and/or another suitable design. Yet alternatively, the support arms 28B can be attached to the cover 28A in a different manner.

Additionally, the support arms 28B can be made of a thin, strong material like steel, aluminum or plastic, as non-exclusive examples. The support arms 28B can also be formed so a stiffening ridge is created, thus enabling the use of thinner lightweight material gauges. Further, an interleaver structure can be utilized which forms a stiff mounting surface for the support arms 28B. With this design, a more rigid structure can be formed for the support arms 28B. The interleaver structure can be made of and/or include soft magnetic elements to serve as a means to securely store the support arms 28B at any desired angle, and also to inhibit stray magnetic fields while the support arms 28B are stored.

Further, in certain embodiments, the generation assembly 10 can further include a coupler assembly 34 to removably and selectively couple the solar panel assembly 14 to the cover assembly 28 in one or more locations. The coupler assembly 34 can have any suitable design, e.g., mechanical and/or magnetic, that better enables the cover assembly 28 to effectively and securely support the solar panel assembly 14 when the solar panel assembly 14 is in the open (unfolded) configuration during use of the generation assembly 10. For example, in some such embodiments, the coupler assembly 34 can include one or more spaced apart first coupler members 34A that are secured to each of the support arms 28B, and one or more spaced apart, second coupler members 34B (shown, for example, in FIG. 6A) that is secured to the back surface 14B of (or integrated into) the solar panel assembly 14. The coupler members 34A, 34B should be positioned such that the coupler members 34A, 34B can effectively engage one another when the support arms 28B are positioned to extend away from the cover 28A during use of the generation assembly 10.

In one embodiment, the first coupler member 34A can include a first magnet, e.g., a magnetic disc or plate, and the second coupler member 34B can include a second magnet, e.g., a magnetic or metal disc (e.g. a washer such as a soft steel washer) or plate, that attracts the first coupler member 34A. Alternatively, the coupler members 34A, 34B, as described, can be reversed such that a magnetic disc is secured to the back surface 14B of the solar panel assembly 14, and a magnetic or metal washer is secured to each of the support arms 28B (or no washer if the support arms 28B are metal). Still alternatively, the coupler assembly 34 and/or the coupler members 34A, 34B can have another suitable design. For example, the coupler members 34A, 34B can include hook-and-loop material, snaps, two-sided tape, lip/groove combinations, bumps/indentations combinations, or other suitable devices.

As noted above, the adjuster assembly 30 enables the position of the cover assembly 28 to be selectively adjusted relative to the base assembly 26 between the storage configuration and the various positions within the operational configuration such that the solar panel assembly 14 can be pointed appropriately toward the sun 11. The design of the adjuster assembly 30 can be varied. In one embodiment, the adjuster assembly 30 includes a friction hinge that enables the cover 28A to be positioned at any desired angle relative to the base 26A. Alternatively, the adjuster assembly 30 can have another suitable design. For example, in one non-exclusive alternative embodiment, the adjuster assembly 30 can include a brace with notched features that extends from the cover 28A and a serrated rack on the base 26A that allows the angle of the cover 28A relative to the base 26A to be fixed at a number of discrete positions. The discrete slot positions can be labeled so that it is easy to direct the user to utilize the correct slot for the intended or desired solar elevation angle. It should be appreciated that in such embodiment, the components of the adjuster assembly 30 can be reversed such that the notched brace extends from the base 26A and the serrated rack is mounted on the cover 28A.

In certain embodiments, when the support assembly 16 is in the storage configuration, the solar panel assembly 14, with the solar panels 22 being in the closed (folded) configuration, as well as the control assembly 20 and all its associated cables and electronics, can be stored within the rigid case 16. In particular, in such embodiments, the foldable, solar panel assembly 14 and the support assembly 16 can be sized and shaped such that the solar panel assembly 14 can be conveniently stowed like commonly-carried items such as paperback books, e-readers/tablets, portfolios, laptop computers, etc. inside the support assembly 16, i.e. with the support assembly 16 in the closed configuration. In such closed configuration, the support assembly 16 can have an attractive design with styles similar to hard-side luggage, and a paperback book-like appearance. The sturdy box base 26A and cover 28A provide mechanical protection to the folded, solar panel assembly 14 from external damage during transport and storage, thus permitting utilization of very lightweight but fragile solar panel construction (e.g., thin, high efficiency crystalline solar cells).

The positioning assembly 18 is configured to enable the solar panel assembly 14 to be best angled toward the sun 11, i.e. in terms of orientation and elevation, at any given time for purposes of achieving improved efficiency in the collection of solar rays and, thus, improved efficiency in solar energy generation. More particularly, the positioning assembly 18 can be configured to assist the user, i.e. provide feedback to the user, as to how the position of the solar panel assembly 14 relative to the sun 11 needs to be adjusted, if at all, such that the solar panel assembly is accurately pointed toward the sun 11 in order to achieve the most efficient collection of solar rays. As provided herein, the positioning assembly 18 can include one or more signal-generating members that generate a signal that is based, at least in part, on the position of the sun 11 relative to the signal-generating member. Stated in another manner, the solar rays of the sun 11 hitting the signal-generating member create the signal that is generated by the signal-generating member. Additionally, the signal is directed toward, received and/or interpreted by one or more signal-receiving members. For example, the one or more signal-generating members can include a drilled hole or a mechanical protrusion, that with the parallel rays of the sun 11 generates the signal, e.g., creates light and shadow patterns, that is received and/or interpreted by the one or more signal-receiving members in order to facilitate accurate orientation of the solar panel assembly 14 toward the sun 11. More specifically, in certain embodiments, the signal impinging on the signal-receiving member can indicate to the user that the solar panel assembly 14 is accurately pointed toward the sun 11. By enabling optimal orientation of the solar panel assembly 14 toward the sun 11, the generation assembly 10 can produce two or three times more energy than an assembly having solar panels laid flat on the ground (depending on the user's latitude and the time of day).

The specific design of the positioning assembly 18 can be varied to suit the requirements of the generation assembly 10. Various embodiments of the positioning assembly 18 will be described in greater detail herein below.

The control assembly 20 can include an electronics system that provides the desired control for the efficient generation of solar energy with the generation assembly 10, as well as managing the conversion and transfer of the generated energy to the one or more portable devices 12. Additionally, as described in detail herein, the control system 20 can be further connected to one or more remote devices 36 for purposes of enabling the user to effectively monitor the entire process of energy generation and transfer such that energy can be generated and transferred in a more efficient manner. The control assembly 20 can include one or more processors and circuits for performing and/or enabling such functions.

As shown, the control assembly 20, e.g., the electronics system, can be housed in an enclosure, e.g., a plastic enclosure, that has openings for input and output connections. Additionally, in certain embodiments, the entire enclosure of the control assembly 20 can be permanently attached to the base 26A of the support assembly 16. Alternatively, the enclosure of the control assembly 20 can be removably attached to the base 26A of the support assembly 16. Still alternatively, the enclosure can be secured to another part of the generation assembly 10.

In certain embodiments, the solar panel assembly 14 can include output electrical connections 38, e.g., a junction box, that can be positioned along the back surface 14B of the solar panel assembly 14. As shown, the output electrical connections 38 are attached to the control assembly 20, i.e. the electronics system, that facilitates optimal set-up of the generation assembly 10 by the user. The control assembly 20, as noted, then manages the efficient conversion and transfer of solar panel generated energy into the one or more portable devices 12.

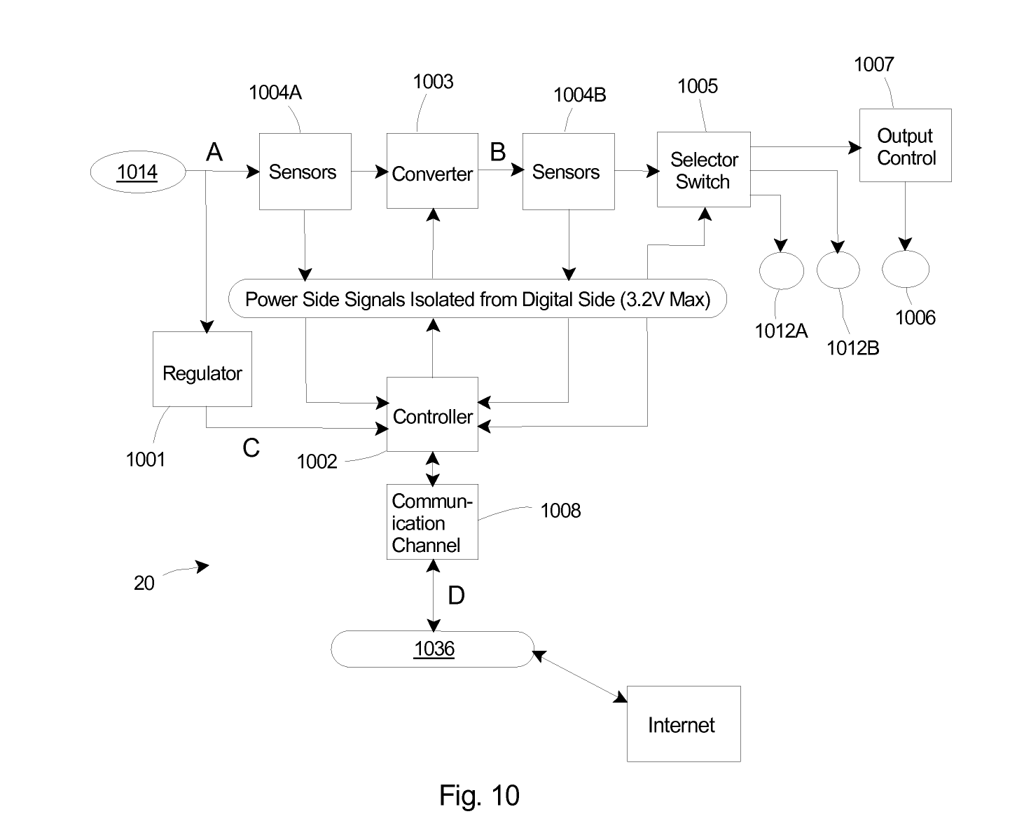

Referring now to FIG. 10, a block diagram of an embodiment of the control assembly 20, i.e. the electronics system, is illustrated. In this embodiment, raw solar panel electricity is supplied from a solar panel assembly 1014 and is applied at input plug “A”. A portion of the energy from the solar panel assembly 1014 is then diverted to a power regulator 1001, where it is regulated and then directed to power a microprocessor-based controller 1002 at input plug “C”. The controller 1002 (including a processor) is tasked with supervising and controlling a power converter 1003, e.g., a DC-DC converter such as a buck converter, such that the desired energy is directed generally toward one or more portable devices 1012A, 1012B (two are illustrated in FIG. 10) at input plug “B”. Additionally, the controller 1002 further utilizes one or more sensors 1004A for measuring the voltage (V) and current (I) coming in from the solar panel assembly 1014, as well as one or more sensors 1004B for measuring the voltage (V) and current (I) being directed toward the one or more portable devices 1012A, 1012B that are to be charged. Utilizing such voltage and current measurements, the controller 1002 adjusts the converter 1003, e.g., the DC-DC converter, such that the I-V energy generation point of the solar panel assembly 1014 is kept at its maximum power point. Thus, the generation assembly 10 (illustrated in FIG. 1A) produces the maximum amount of energy producible under the current operating conditions of solar insolation and solar panel orientation. The controller 1002 can be designed to only deviate from this peak power point operating condition when it detects too much energy flowing into the portable devices 1012A, 1012B being charged. For example, such conditions may arise when small batteries are being charged, or when a device being charged eventually nears full charge and needs to have its charging input power reduced and eventually stopped when the device becomes full. The charging condition of the portable devices 1012A, 1012B can be inferred by the control assembly 20 by observing the output I and V measured values as the devices 1012A, 1012B become full (e.g., voltage elevation, current decrease, apparent ESR increase).

It should also be recognized that the control assembly 20 can also implement safety features, and system diagnostics. For example, the control assembly 20 can vary the DC-DC duty cycles to trace out the I-V curve of the solar panel assembly 1014 at current operating conditions. An I-V curve for a solar panel assembly is very informative about its particular construction type and any possible damage that may have occurred (e.g., broken wires or cracked cells). The control assembly 20 can also detect safety conditions like over-temperature, or output electrical shorts, and then shut down the generation system 10 before any damage occurs, and inform the user about any detected problems.

As noted above, the block diagram of the control assembly 20 also shows multiple portable device outputs 1012A, 1012B present. The control assembly 20 can enable or disable each output as desired via an output selector switch 1005. In this manner, in one representative application, the electronics can first charge one attached portable device 1012A, and then automatically switch to charging a second portable device 1012B when the first portable device 1012A becomes full. All possible permutations of how and when one or more devices 1012A, 1012B get charged can be as directed by algorithms or user commands.

It is common today for solar charging systems to charging multiple devices simultaneously. The downside of simultaneous charging is that if there is only a limited amount of time in the sun available, each device under charge will acquire too little energy to be useful. Thus, as provided herein, one method includes at least initially directing all the power to a single device, so at least one device would be useful at the end of the available charging period. By automatically managing the charging of multiple attached devices and automatically switching over from one device to the next, no time is lost due to waiting for the user to disconnect or attach devices for charge. This design can save a great deal of charging time that would otherwise be lost in typical solar power systems when used for charging multiple devices.

In some embodiments, the control assembly 20 can also enable a data path and method for the control assembly to query any portable device 1012A, 1012B being charged for a unique identification signal. This idea could be useful for communicating the device's chemistry, manufacturer, and/or preferred charging regimen (volts and amps). In the case of a USB output 1006, illustrated in FIG. 10 is an implementation of detecting and then asserting the proper electrical voltages and resistance on terminals D+ and D− with an output control 1007 to put the USB devices 1006 into a mode where they will accept charging energy at their maximum possible rates. This USB detection and signal assertion can be done, for example, by a device such as a TI TPS2511 chip.

As provided herein, the control assembly 20 can also communicate conditions or other associated feedback to the user utilizing attached LEDs, and/or an audio speaker. A particular signal sequence can be used to signal that the proper attachment and operation of the solar panel assembly 1014 has been achieved during initial setup (e.g., a blink sequence and/or an audio beep sequence). Additionally, ongoing power flow indications can be accomplished by an audio tone that varies its pitch and volume modulation according to monitored quantity such as wattage or current. Such an audio indicator can be an aid for the user to optimally point the solar panel assembly 1014 to the sun by finding the orientation that maximizes the pitch. Further, as shown, a user input pushbutton can also be provided that can be utilized by the user to select desired operating modes or tests to be conducted.

Additionally, the control assembly 20 can also include a wireless communications channel 1008 (e.g., Bluetooth Low Energy or Wi-Fi) that can be unidirectional (generation assembly-to-remote device) or bi-directional. The usefulness of such a communications channel 1008 is that a remote device 1036 capable of receiving the communications (e.g., an iPhone running the proper application) would be capable of displaying to the user the operating conditions occurring in the generation assembly 10 which may be located several meters away, and out of sight as noted at input plug “D”. It would also provide a superior user interface to facilitate sending complex commands to the electronics for operating procedures that would be difficult to implement with simple button presses on the electronics box.

As detailed herein, some embodiments can also include an associated monitor application running on a remote device 1036, e.g., an intelligent device such as the user's iPhone, which may also be connected to the Internet. The monitor application is running while in communications with the generation assembly 10 electronics using its communication medium (e.g., Bluetooth Low Energy, Wi-Fi, or even wired). The data stream can be the measured current and voltage of the solar panel assembly 14, and the current and voltage of the portable device 12 being charged. Other data points can also be communicated such as temperature, time since charging began, attached devices for charging, safety conditions, etc. A wireless communications channel (e.g., Bluetooth Low Energy or Wi-Fi) can also be provided, which can be unidirectional (generation assembly-to-remote device). The monitor application can use the communicated data stream sent by the generation assembly 10 as well as information provided by the user's remote device 1036 where the app is running (e.g., iPhone) and construct useful displays and provide useful functions to the user.

Returning back to FIG. 1A, a number of potential applications will be discussed in relation to the remote device 36. More specifically, various potential applications may be downloaded to the remote device 36 and run and displayed on a display screen 36A of the remote device 36. For example, in one potential application, the display screen 36A can include information relating to the current and voltage being delivered to the portable device 12 being charged. This application can locally multiply the current and voltage to compute the current wattage, and can integrate the wattage over time to provide the total energy watt-hours produced during the current charging episode. It should be understood that additional features such as historical records of prior charging episodes can also be shown.

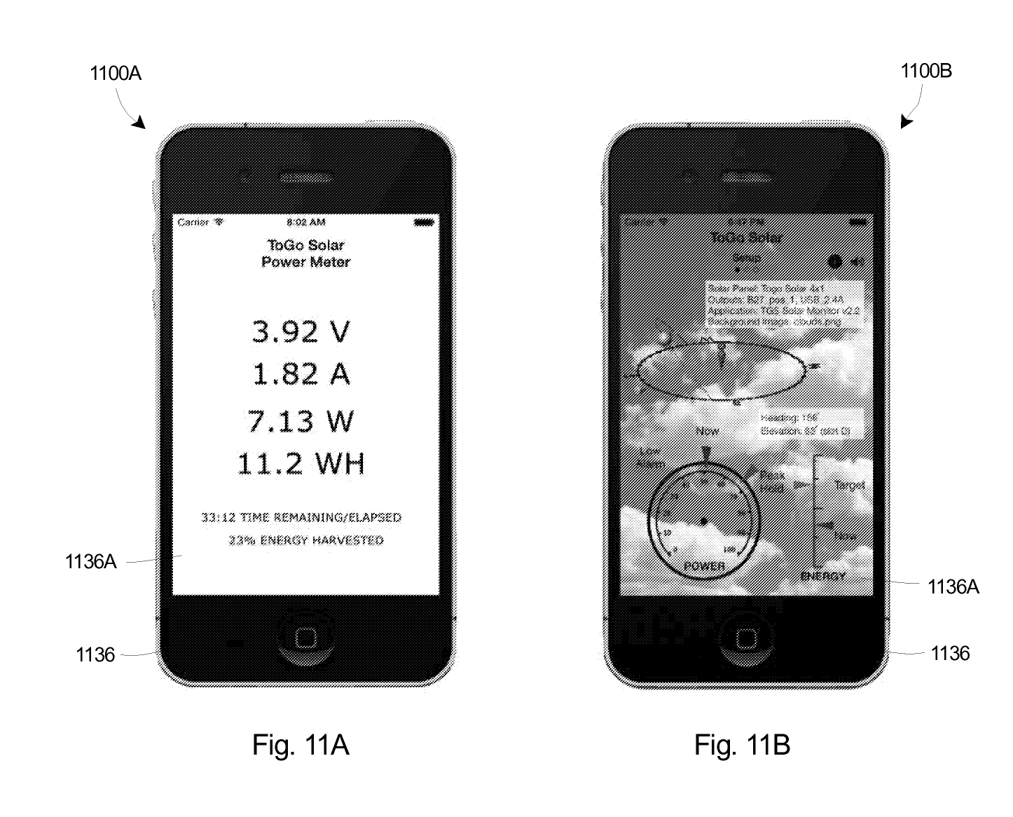

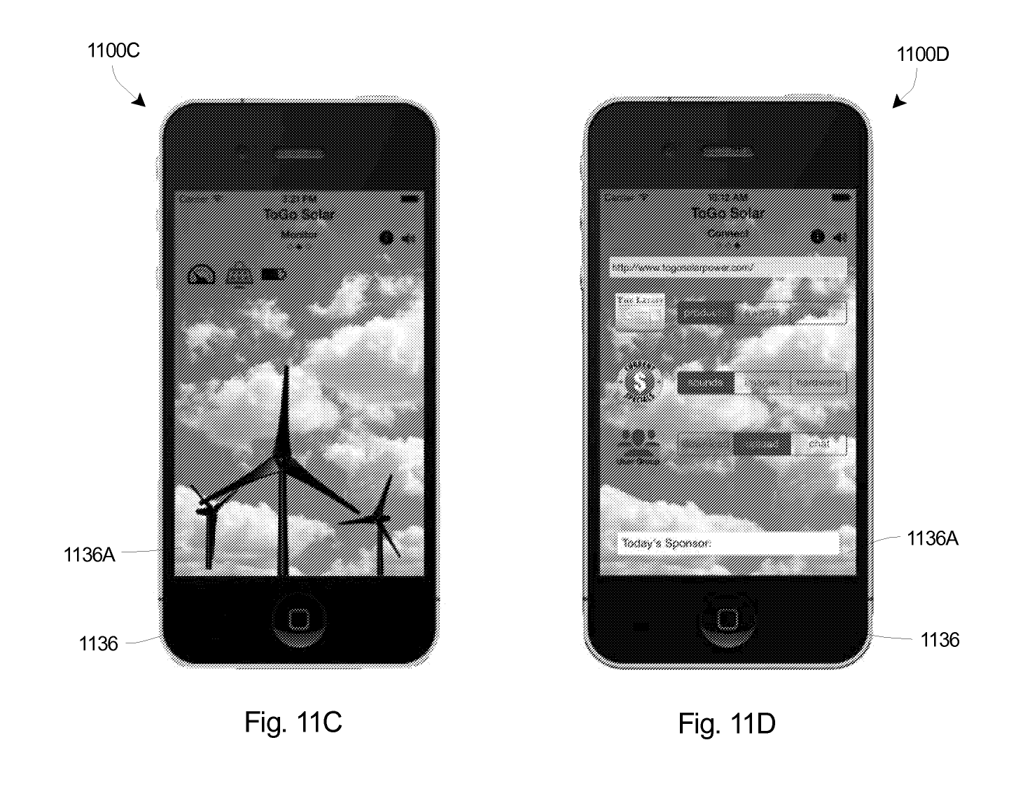

A screen grab 1100A that illustrates certain features and aspects of this first potential application usable with the generation assembly 10 that can be run on the remote device 1136 and shown on the display screen 1136A of the remote device is shown in FIG. 11A.

In another potential application, the display screen 36A can be utilized to aid the user in properly setting up the generation assembly 10 for proper connections and orientation toward the sun 11 for maximum charging efficiency and speed. For example, the display screen 36A can show the desired orientation and elevation for positioning the solar panel assembly 14, which can be found by using the user's latitude and longitude, and the current time. The internal magnetic compass and accelerometers of the remote device 36 can also be used to provide graphical indications to which way the solar panel assembly 14 should be pointed. Textual information can advise the user of the preferred settings for the adjuster assembly 30 so as to achieve the best elevation for the cover assembly 28 (and thus the solar panel assembly 14) relative to the base assembly 26. Having such an app to facilitate pointing of the solar panel assembly 14 would be particularly useful if a large cloud is covering the sun 11 or if the user is standing in front of the solar panel assembly 14 during set-up (e.g., if the support assembly is up against a wall or tree). The app also allows the user to send commands like which portable device 12 of several attached to charge first, or to run system diagnostics such as panel I-V curves.

During operation, real-time wattage meters can graphically show the user how well the solar panel assembly 14 is pointed and how much wattage the current sun conditions are producing. Additionally, charging functions like peak power tracking (PPT) and output device switchover when multiple portable devices 12 are being charged together can also be shown to the user. The display screen 36A for this application can also permit the user to set alarms or alerts, e.g., utilizing audio beeps and/or LED lights, that are useful for indicating when the user should take some action, as discussed above. As provided herein, alarms can be useful so that the user need not be constantly monitoring the charging process, yet is still able to take immediate action when required to minimize overall time to charge.

One alarm that can be set by the user relates to a minimum power level, e.g., a minimum solar wattage output. The minimum power level alarm would be invoked when the charging power falls below the user setting. This could occur from simply a cloud passing over the sun 11, which requires no user action; or it could occur from the wind blowing the solar panel assembly 14 over, or the sun 11 moving sufficiently across the sky, which both require the user to re-point the solar panel assembly 14. Thus, the monitor application can advise the user when to periodically adjust the position of the solar panel assembly 14 toward the sun 11 so that it will be producing high power at all times. With this design, the desired solar charging will take the minimum amount of user charging time in the sun and minimum amount of mental attention, thereby increasing the time the user is powered up and mobile. This is much more convenient than current practices of waiting for hours in the sun, unaware of the effectiveness of the solar charging progress being made. Additionally, with this design, the user does not need to pay close attention to the generation assembly 10 as it is charging; the smartphone application on the remote device 36 will do it. Further, such alarms could be invoked if a thief was attempting to steal the generation assembly 10. All of these conditions can be uniquely identified by the application by monitoring the power level fluctuations and the wireless communications signal strength.

Another alarm that can be set by the user relates to the amount of energy generated. This alarm can be useful for when the user is time-constrained and simply wants to gather a specific amount of energy, not necessarily a full battery charge. For example, this could be because the user wishes to gather a half-smartphone's worth of energy to get through the rest of his day, and to do so as quickly as possible. The energy generated alarm would notify the user at the earliest time possible when the user can stop the solar charging, pack up the generation assembly 10, and continue on his way.

A screen grab 1100B that illustrates certain features and aspects of this second potential application usable with the generation assembly 10 that can be run on the remote device 1136 and shown on the display screen 1136A of the remote device is shown in FIG. 11B.

In still another potential application on the remote device 36, the display screen 36A can be utilized to display ongoing operations of the solar panel assembly 14. After setting up the generation assembly 10, the generation assembly 10 spends the majority of its time (minutes to hours) in the sun 11 absorbing energy and charging the attached portable device(s) 12. A user may wish to periodically glance at the display screen 36A to quickly assure continued proper operation and ascertain charging progress. A unique way is to use animating graphical elements to serve as indicators of operation. For example, the application can illustrate wind turbines whose blades spin faster or slower depending on level of watts being currently generated. It should also be appreciated that the app can monitor more than just a single generation assembly 10 at once (each generation assembly 10 would have its own avatar, which can all be displayed simultaneously). Additionally and/or alternatively, other graphical elements that are also usable could be avatars like spinning Ferris Wheels, or roller coasters, or even walking cartoon characters. Whimsical moving elements are much easier for users to quickly glance at and tell proper operations than a changing set of numerals indicating wattage. Additionally, graphical elements can be added and re-arranged on the screen by the user.

Audio streams can also be utilized for displaying real-time streaming data from the generation assembly 10. An audio stream can be constructed so that its pitch rises or falls according to the magnitude of a monitored signal—current, for example. The audio signal can also be altered by modifying the volume modulation. An example of this could be the slow or rapid volume modulation like in a Geiger radiation counter. In this manner, two data streams could be encoded in the audio signal simultaneously. A usage example of this is when you wish to orient both the heading and elevation of the solar panel assembly 14 toward the sun 11. The remote device 36 could utilize its internal compass and accelerometer and compare it to the desired heading and elevation by coding elevation as a pitch that rises when close to the goal and falls the further away from the elevation goal it gets. The user would adjust the orientation of the remote device 36 attempting to point the remote device 36 toward the sun. The app would create a sound stream where it could code the proximity to the heading (compass) goal as a modulation in volume that goes from a low frequency duty cycle ON signal when far away to a higher and higher frequency ON duty cycle until it is continuously on when at the correct heading. The final objective orientation of the solar panel assembly 14 would be shown by the phone's orientation, and the user would point the solar panel assembly 14 to be parallel to the now correctly pointed surface of the remote device 36.

A screen grab 1100C that illustrates certain features and aspects of this third potential application usable with the generation assembly 10 that can be run on the remote device 1136 and shown on the display screen 1136A of the remote device is shown in FIG. 11A.

In yet another potential application, the display screen 36A can display information generated by the user for communicating to other locations, e.g., the Internet. The display screen 36A can also display information downloaded from the Internet. The purpose of the display screen 36A in this application would be to provide a communications channel for the user and his generation assembly 10 to the manufacturer and to other users. Information such as special offers for items to purchase, messages from sponsors (ads), product alerts, messages from other users, etc. can be retrieved from the Internet and displayed. The user can also send data up to the Internet comprising things like user-constructed messages, current system operation parameters, current location, etc. The display screen 36A in this embodiment can be utilized for improving and enriching the user's experience with the generation assembly 10 by connecting it to the Internet.

A screen grab 1100D that illustrates certain features and aspects of this fourth potential application usable with the generation assembly 10 that can be run on the remote device 1136 and shown on the display screen 1136A of the remote device is shown in FIG. 11D.

As described herein, the various monitoring applications described provide a graphical environment to communicate with the user, which typically take over the entire screen of the remote device 36. However, the application can alternatively be run in the background of the remote device 36, with little or no graphical elements on the display screen 36A. With this design, when an alarm is triggered, the monitoring application would then use the messaging system of the remote device 36 to interrupt the user's operation and inform the user of what alarm was triggered, what action should be taken, etc. Android and iOS have messaging systems to do this, but others such as SMS messages are also possible.

Additionally, FIG. 1B is a front perspective view of the solar energy generation assembly 10 illustrated in FIG. 1A. In particular, FIG. 1B more clearly illustrates certain additional features and aspects of the solar panel assembly 14, i.e. the solar panels 22, and the support assembly 16.

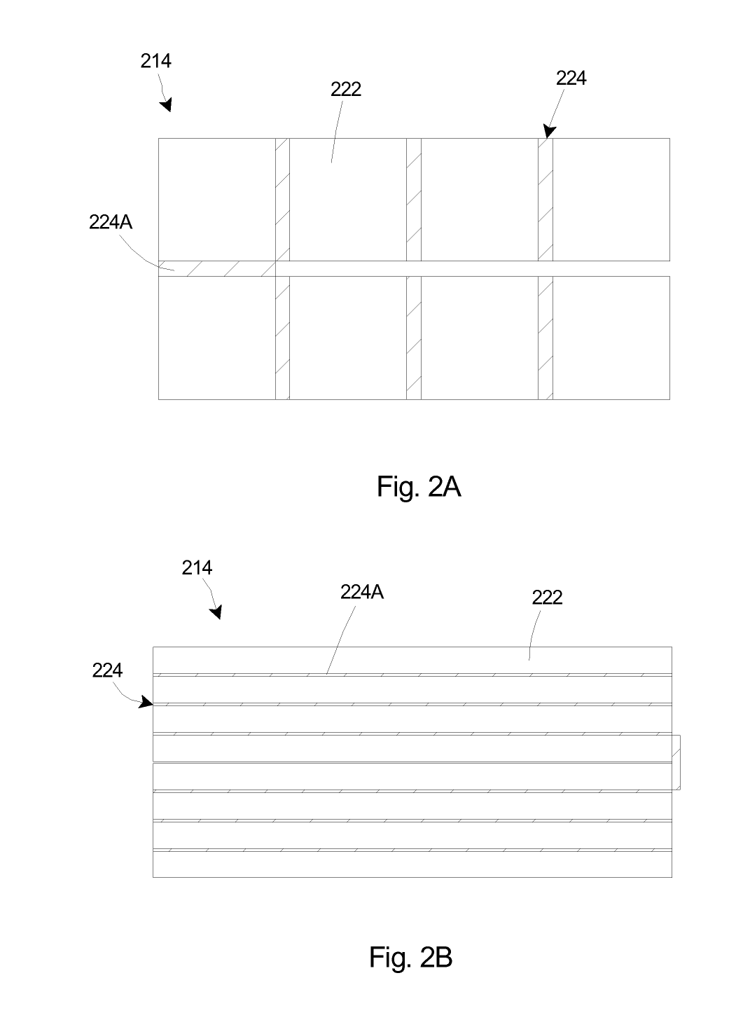

FIG. 2A is a simplified schematic illustration of an embodiment of the solar panel assembly 214 usable as part of the solar energy generation assembly 10 illustrated in FIG. 1A. As shown in FIG. 2A, in this embodiment, the solar panel assembly 214 includes eight individual solar panels 222 that are coupled together and that can be opened up and arranged in a substantially planar, four-by-two array. Additionally, FIG. 2B is another simplified schematic illustration of the solar panel assembly 214 illustrated in FIG. 2A. As noted above, in various embodiments, the solar panel assembly 214 is configured to be selectively movable between an open (unfolded) configuration (as shown in FIG. 2A) and a closed (folded) configuration (as shown in FIG. 2B).

Additionally, as noted above, the solar panel assembly 214 includes a connector assembly 224 including a plurality of connectors 224A that are specifically designed to enable the solar panel assembly 214 to be easily moved between the open configuration and the closed configuration. The connectors 224A can have any suitable design, such as was discussed in detail herein above.

As shown in FIG. 2A, connectors 224A are provided between adjacent solar panels 222 within each row of four. However, connectors 224A are only provided between adjacent solar panels 222 in one of the four columns, i.e. in one of the end columns. With this design, the solar panels 222 are connected in a manner similar to a pair of pants, which allows for easy folding of the solar panels 222 as there is only a single layer of material folding at any joint.

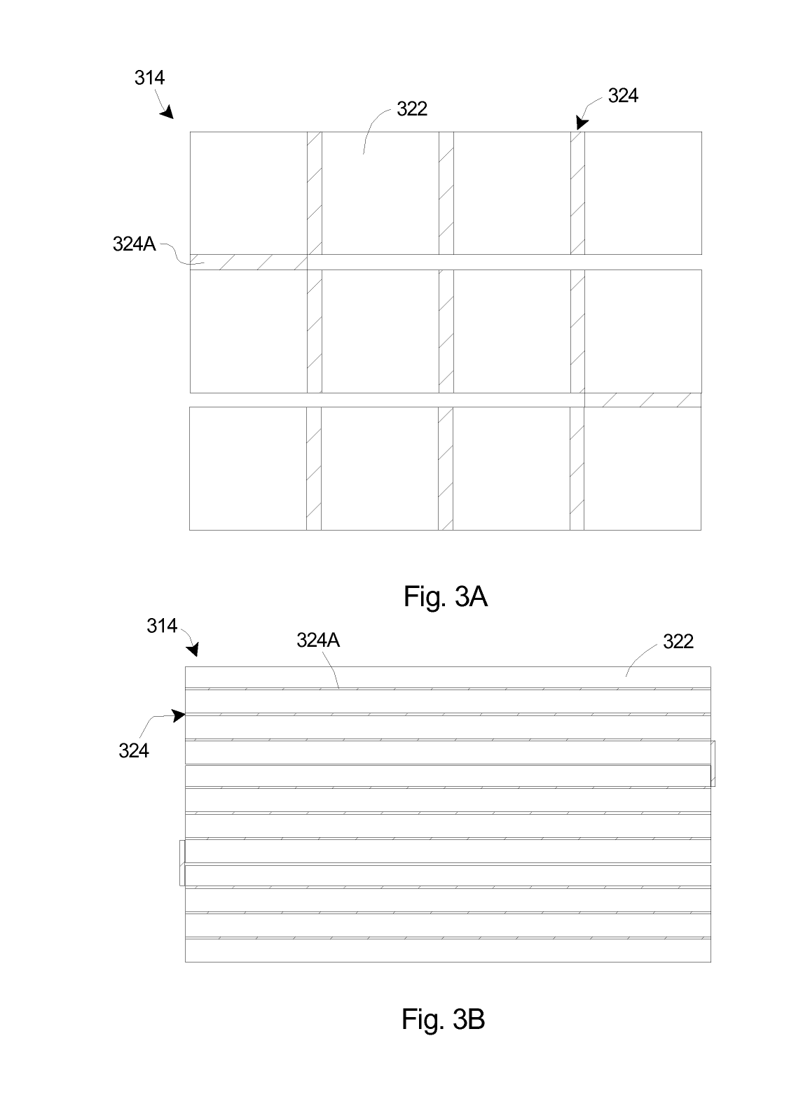

FIG. 3A is a simplified schematic illustration of another embodiment of the solar panel assembly 314 illustrated in FIG. 1A. As shown in FIG. 3A, in this embodiment, the solar panel assembly 314 includes twelve individual solar panels 322 that are coupled together and that can be opened up and arranged in a substantially planar, four-by-three array. Additionally, FIG. 3B is another simplified schematic illustration of the solar panel assembly 314 illustrated in FIG. 3A. As with the previous embodiments, the solar panel assembly 314 is again configured to be selectively movable between an open (unfolded) configuration (as shown in FIG. 3A) and a closed (folded) configuration (as shown in FIG. 3B).

Additionally, in the embodiment illustrated in FIGS. 3A and 3B, the solar panel assembly 314 further includes a connector assembly 324 including a plurality of connectors 324A that are specifically designed to enable the solar panel assembly 314 to be easily moved between the open configuration and the closed configuration.

As shown in FIG. 3A, connectors 324A are provided between adjacent solar panels 322 within each row of four. However, connectors 324A are only provided between adjacent solar panels 322 between adjacent rows in one of the four columns. In particular, connectors are only provided in one end column between the solar panels 322 in the first and second rows, and connectors are only provided in the other end column between the solar panels 322 in the second and third rows. With this design, the solar panels 322 can again be easily folded as there is only a single layer of material folding at any joint.

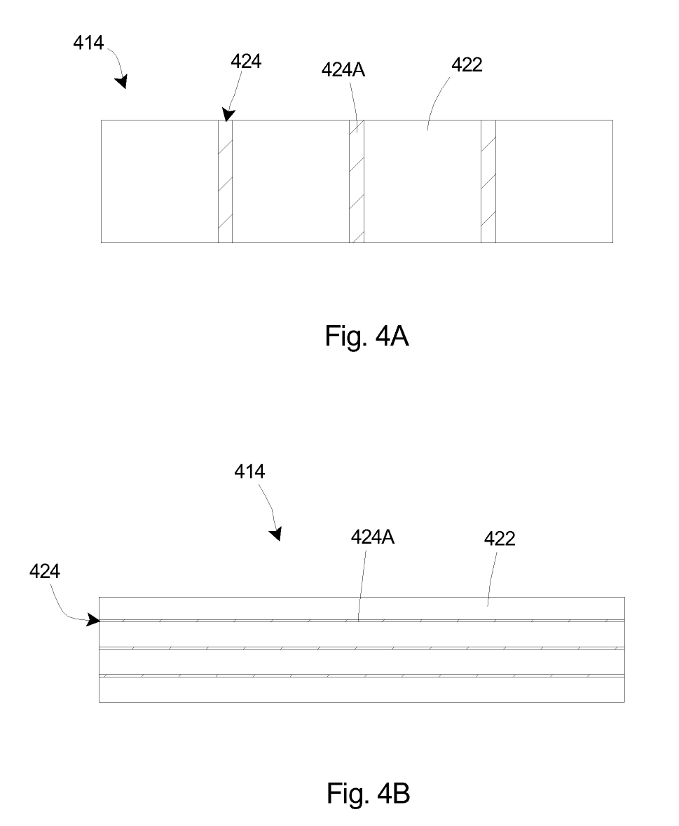

FIG. 4A is a simplified schematic illustration of still another embodiment of the solar panel assembly 414. As illustrated in FIG. 4A, in some embodiments, the solar panel assembly 414 can include four individual solar panels 422 that are coupled together and that can be opened up and arranged in a substantially planar, four-by-one array. Additionally, FIG. 4B is another simplified schematic illustration of the solar panel assembly 414 illustrated in FIG. 4A. Similar to the previous embodiments, the solar panel assembly 414 is again configured to be selectively movable between an open (unfolded) configuration (as shown in FIG. 4A) and a closed (folded) configuration (as shown in FIG. 4B).

Additionally, as with the other embodiments, the solar panel assembly 414 further includes a connector assembly 424 including a plurality of connectors 424A that are specifically designed to enable the solar panel assembly 414 to be easily moved between the open configuration and the closed configuration. As shown in FIG. 4A, connectors 424A are provided between each pair of adjacent solar panels 422.

FIGS. 5A and 5B are alternative exploded perspective views of an embodiment of a solar panel assembly 514, i.e. a four-by-one array, that is usable as part of the solar energy generation assembly 10 illustrated in FIG. 1A. In particular, FIG. 5A is a top exploded perspective view of the solar panel assembly 514, and FIG. 5B is a bottom exploded perspective view of the solar panel assembly 514 illustrated in FIG. 5A. It should be appreciated that the four-by-one panel array illustrated in FIGS. 5A and 5B can comprise a complete solar panel assembly or only a portion of a larger solar panel assembly. Stated in another manner, in certain embodiments, the solar panel assembly 514 can be a four-by-two array, a four-by-three array, or another size array of solar panels.

As noted above, the solar panel assembly 514 is configured to sturdy, yet very flexible to enable the solar panels to be quickly and easily moved (i.e. folded and unfolded) between the open (unfolded) configuration and the closed (folded) configuration. Additionally, the design of the solar panel assembly 514 can be varied to suit the specific requirements of the generation assembly 10. More specifically, the number of layers and the design of each layer of the solar panel assembly 514 can be varied. In the embodiment illustrated and described in relation to FIGS. 5A and 5B, the solar panel assembly 514 is constructed of a lamination of thin materials and includes five layers, i.e. a first layer 540A, a second layer 540B, a third layer 540C, a fourth layer 540D and a fifth layer 540E. Alternatively, the solar panel assembly 514 can include greater than five layers or fewer than five layers without departing from the intended scope of the present invention. Additionally and/or alternatively, it should be appreciated that an adhesive layer, or simply an adhesive, can be provided between any of the layers shown as a means to more securely bond the layers together.

In this embodiment, the first layer 540A is a top layer that is configured to face toward, and thus be closest to, the sun 11 (illustrated in FIG. 1A) during collection of solar rays. In certain embodiments, the first layer 540A can made formed from a thin transparent film, such as ethylene tetrafluoroethylene (ETFE), so that the solar rays can easily pass through the first layer 540A. ETFE is a fluorine-based plastic that is designed to have high corrosion resistance and strength over a wide temperature range. Additionally, in some embodiments, the first layer 540A can have a thickness of between approximately 0.01 millimeters and 0.05 millimeters. Alternatively, the first layer 540A can be thicker than 0.05 millimeters or thinner than 0.01 millimeters, and/or the first layer 540A can be formed from another suitable transparent material.

The second layer 540B is positioned substantially between the first layer 540A and the third layer 540C and can function as an encapsulant that is designed to provide solar cells with improved durability and protection against corrosion and delamination. In some embodiments, the second layer 540B can be formed from ethylene-vinyl acetate (EVA), which is soft and flexible, and can provide good clarity and gloss, low-temperature toughness, stress-crack resistance, hot-melt adhesive waterproof properties, and resistance to UV radiation. Additionally, the second layer 540B can have a thickness between approximately 0.1 millimeters and 0.5 millimeters. Alternatively, the second layer 540B can be thicker than 0.5 millimeters or thinner than 0.1 millimeters, and/or the second layer 540B can be formed from another suitable material.

Additionally, as illustrated in FIGS. 5A and 5B, the second layer 540B can have cutout portions that can be positioned to further enhance the folding process.

The third layer 540C is positioned substantially between the second layer 540B and the fourth layer 540D. As shown, the third layer 540C includes a plurality of solar panels 522 that are utilized for collecting solar rays from the sun 11. In one embodiment, each solar panel 522 can include six silicon solar cells 542 that are wired in series. Alternatively, each solar panel 522 can include greater than six or fewer than six silicon solar cells 542.

Additionally, as shown more clearly in FIG. 5B, the solar cells 542 can be adhesively bonded to a rigid support plate 544. The support plate 544 is configured to provide rigid support for the solar cells 542 so that all of the solar cells 542 can be properly oriented toward the sun 11. In one embodiment, the support plate 544 can be formed from G10 epoxy fiberboard, although the support plate 544 can also be formed from and/or include other suitable materials.

The third layer 540C can further include the connector assembly 524 that flexibly connects the solar panels 522 together. In particular, as provided above, the solar panels 522 are flexibly joined together, both electrically and mechanically, by connectors 524A that extend between adjacent solar panels 522; although it should be appreciated that one or more of the other layers 540A, 540B, 540D, 540E can also aid in the mechanical connection between adjacent solar panels 522.

Further, as noted above, the connectors 524A can be formed from and/or include perforated metal conductors, e.g., a flexible perforated copper mesh or other suitable materials. This provides a thin, very flexible and very durable electrical connection that is superior to conventional interconnects. By spreading the electrical current across a wider width and perforating the conductors, thinner metal can be used. Additionally, as the metal elements undergo twist as well as bending when the solar panels 522 are folded, the result is a more flexible hinge that resists cracking due to repeated bending and can permit sharp folding radii.

In certain embodiments, as shown in FIG. 5B, each of the solar panels 522 can further be secured to adjacent solar panels 522 with one or more strips of conductive tape 546.

In some embodiments, the third layer 540C can have an overall thickness of between approximately 0.8 millimeters and 1.2 millimeters. Alternatively, the third layer 540C can have an overall thickness that is greater than 1.2 millimeters or less than 0.8 millimeters.

The fourth layer 540D is positioned substantially between the third layer 540C and the fifth layer 540E. Similar to the second layer 540B, the fourth layer 540D can also function as an encapsulant that is designed to provide solar cells with improved durability and protection against corrosion and delamination. The fourth layer 540D can also similarly be formed from EVA or another suitable material.

Additionally, the fourth layer 540D can have a thickness between approximately 0.1 millimeters and 0.5 millimeters. Alternatively, the fourth layer 540D can be thicker than 0.5 millimeters or thinner than 0.1 millimeters. Still alternatively, the solar panel assembly 514 can be designed without the fourth layer 540D.

In this embodiment, the fifth layer 540E is a bottom layer that can be positioned to substantially directly contact the cover assembly 28 (illustrated in FIG. 1A) of the support assembly 16 (illustrated in FIG. 1A) when the solar panel assembly 514 is positioned to collect solar rays from the sun 11. In certain embodiments, the fifth layer 540E can made formed from a thin film, such as ETFE or polyethylene terephthalate (PET, which is an excellent water and moisture barrier material). Additionally, in some embodiments, the fifth layer 540E can have a thickness of between approximately 0.01 millimeters and 0.05 millimeters. Alternatively, the fifth layer 540E can be thicker than 0.05 millimeters or thinner than 0.01 millimeters, and/or the fifth layer 540E can be formed from another suitable film material.

The back surface of the fifth layer 540E can also be imprinted with graphics such as branding marks and user instructions for proper usage.

It should be appreciated that although construction of the solar panels 522 has been described using crystalline silicon type solar cells, a similar configuration is realized when using thinner CIGS-style solar panels. They are very flexible and too benefit from folding into a compact form when stored.

FIG. 5C is an enlarged view of a portion of the solar panel assembly 514 illustrated in FIG. 5A. More specifically, FIG. 5C illustrates a portion of a first solar panel 522A, a portion of a second solar panel 522B, and a portion of a non-exclusive embodiment of the connector assembly 524 that can be utilized to flexibly connect the first solar panel 522A and the second solar panel 522B.

As provided herein, the design of the connector assembly 524 can be varied to suit the specific requirements of the generation assembly 10 (illustrated in FIG. 1A) and/or the solar panel assembly 514. In the embodiment illustrated in FIG. 5C, for example, the connector assembly 524 can include two connectors 524A, i.e. a first connector 524AA and a second connector 524AB, a plurality of panel tabs 523, a plurality of first connector tabs 525, and a plurality of second connector tabs 527. Alternatively, the connector assembly 524 can have more components or fewer components than those specifically illustrated in FIG. 5C. For example, in certain non-exclusive alternative embodiments, the connector assembly 524 can be designed without the second connector 524AB. Further, it should be appreciated that the number of panel tabs 523, first connector tabs 525 and second connector tabs 527 can be different than, more or less than, what is specifically illustrated in FIG. 5C.

As illustrated, the first connector 524AA can be utilized as part of a first electrical path, e.g., a positive path, and the second connector 524AB can be utilized as part of a second electrical path, e.g., a negative path. The design of the connectors 524AA, 524AB, e.g., the size, the shape and the materials used, can be varied as desired to suit the requirements of the generation assembly 10 and/or the solar panel assembly 514. Additionally, the connectors 524AA, 524AB can be coupled to the adjacent solar panels 522A, 522B, e.g., by soldering or another suitable method, by a different amount. Moreover, as shown, the connectors 524AA, 524AB, and thus the electrical paths, can be spaced apart by an air gap 529, i.e. a non-conducting air gap. In the embodiment shown in FIG. 5C, each of the connectors 524AA, 524AB extends approximately one-half the height of the solar panels 522A, 522B. Alternatively, in embodiments without the second connector 524AB, the first connector 524AA can extend approximately the entire height of the solar panels 522A, 522B; the connectors 524AA, 524AB can be sized to extend approximately three-fourths and one-fourth of the height of the solar panels 522A, 522B, respectively, and/or the connectors 524AA, 524AB can have different relative sizes to one another.

Additionally, the connectors 524AA, 524AB can be formed from any suitable conducting material. For example, as noted above, in some embodiments, the conductors 524AA, 524AB are formed from a copper material. Alternatively, the connectors 524A can be formed from other suitable materials, including, but not limited to, aluminum, brass, nickel, gold, bronze, platinum, silver, steel, stainless steel, titanium and zinc.

Additionally, the connectors 524AA, 524AB can be formed by any suitable manner. For example, in certain embodiments, the connectors 524AA, 524AB are formed by cutting perforations, i.e. slits, in the material, and then stretching the material such that a screen-like (or chicken wire-like) design is formed. It should be appreciated that holes 531 formed in the screen-like design can be configured in any suitable shape. In some embodiments, as shown, the holes 531 in the connectors 524AA, 524AB can have a substantially hexagon shape. With this design, the connectors 524AA, 524AB form a light weight, netting made from a conductive material that has a hexagonal-shaped mesh. Alternatively, the holes 531 in the connectors 524AA, 524AB can have an octagon shape, a diamond shape, an oval shape or another suitable shape, and the connectors 524AA, 524AB can form an octagon-shaped, a diamond-shaped, an oval-shaped or another suitable shaped mesh.

With this design, the connectors 524AA, 524AB can be thin, relatively wide, and very flexible. Further, with this design, each of the wires of the connectors 524AA, 524AB does not extend directly (straight) between the two solar panels 522A, 522B, but extend at an angle other than ninety degrees relative to the adjacent edges of the two solar panels 522A, 522B. As a result thereof, the wires bend a little and twist when folding the solar panels 522A, 522B instead of just bending. This improves the durability of the connectors 524AA, 524AB.

Further, the thickness of the material can be varied to form connectors 524A of different sizes depending on the requirements of the generation assembly 10 and/or the solar panel assembly 514. In certain embodiments, the material can have a thickness of between approximately 0.05 and 0.10 millimeters. Alternatively, the material can have a thickness of greater than 0.10 millimeters or less than 0.05 millimeters.

The first electrical path, e.g., the positive path, can be used to transfer the potential energy collected from the solar rays of the sun 11 (illustrated in FIG. 1A) to the output electrical connection 38 (illustrated in FIG. 1A) on the back surface 514B of the solar panel assembly 514. In some embodiments, the first electrical path includes the plurality of panel tabs 523, e.g., three coupled to each solar panel 522A, 522B, although only two are visible in FIG. 5C, and the plurality of first connector tabs 525, in addition to the first connector 524AA. It should be noted that the bottom panel tab 523 of each solar panel 522A, 522B is illustrated in phantom because it is covered and electrically insulated from the second connector 524AB.

As shown, the panel tabs 523 are spaced apart from one another and are wrapped around the edge of each solar panel 522A, 522B. The panel tabs 523 are configured to be electrically coupled to the solar cells 542 (illustrated in FIG. 5A) so as to bring the potential energy from the solar cells 542 to the back surface 14B of the solar panel assembly 514. The panel tabs 523 can be coupled to the back surface 514B of the solar panel assembly 514 in any suitable manner such as being folded around the solar panel assembly 514.

The first connector tabs 525, one is shown on each solar panel 522A, 522B are electrically connected to the panel tabs 523 (e.g. via soldering or electrically conductive adhesive) and electrically connected to the first connector 524AA (e.g. via soldering or electrically conductive adhesive). The first connector tabs 525 are configured to transmit the potential energy collected by the solar cells 542 to the first connector 524AA, in order that such potential energy can be moved from one solar panel to an adjacent solar panel.

With this design, for example, the current from the solar cells 542 of the right solar panel 522B can flow from its panel tabs 523, the first connector tabs 525 and the first connector 524AA to the first connector tabs 525 and then the panel tabs 523 of the left solar panel 522A. Subsequently, as provided herein above, such potential energy is then transferred to the control assembly 20 (illustrated in FIG. 1A) for purposes of energy generation.

As shown, the second electrical path, e.g., the negative path, includes the second connector tabs 527 and the second connector 524AB. In certain embodiments, the connector assembly 524 can include four second connector tabs 527 substantially adjacent to the connection between adjacent solar panels 522A, 522B, with two second connector tabs 527 being coupled, e.g., soldered, to each of the solar panels 522A, 522B transverse to one another. The second connector tabs 527 that extend substantially parallel to the height of the solar panels 522A, 522B are electrically coupled to the second connector 524AB, which as shown, extends across the connection from the first solar panel 522A to the second solar panel 522B.

Additionally, as shown, an insulator 533, e.g., a piece of insulating tape, can be positioned to cover two of the panel tabs 523 (illustrated in phantom and one on each solar panel 522A, 522B) so as to effectively insulate the first electrical path from the second electrical path.

FIGS. 6A-6D illustrate different views of another embodiment of the solar energy generation assembly 610 having features of the present invention. The generation assembly 610 is somewhat similar in design and function to the generation assembly 10 illustrated and describe above. For example, the generation assembly 610 includes a solar panel assembly 614 and a storage and support assembly 616 that are somewhat similar to the solar panel assembly 14 and the storage and support assembly 16 illustrated and described above. Accordingly, certain features and aspects of the solar panel assembly 614 and the support assembly 616 will not be repeated herein.

As with the previous embodiments, the solar panel assembly 614 is configured to be selectively moved between an open (unfolded) configuration and a closed (folded) configuration; and the support assembly 616 is configured to be selectively moved between an operational configuration and a storage configuration. More specifically, FIG. 6A is a perspective view of the generation assembly 610 with the solar panel assembly 614 being in the open configuration, and with the support assembly 616 being in the operational configuration; FIG. 6B is perspective view of a portion of the generation assembly 610 illustrated in FIG. 6A (the solar panel assembly 614 has been omitted from FIG. 6B for purposes of clarity), with the support assembly 616 again being in the operational configuration; FIG. 6C is a perspective view of the generation assembly 610 illustrated in FIG. 6A, with the solar panel assembly 614 being in the closed configuration and the support assembly 616 being in the operational configuration; and FIG. 6D is a perspective view of the generation assembly 610 illustrated in FIG. 6A, with the support assembly 616 being in the storage configuration.

Although, as noted, many similarities exist between the generation assembly 610 illustrated in FIGS. 6A-6D and the previous embodiments of the generation assembly 10, the generation assembly 610 has support arms 628B and an adjuster assembly 630 that are somewhat different than what was illustrated and described in the previous embodiments. Additionally, it should be noted that FIG. 6A also illustrates the solar panel assembly 614 being a four-by-one panel array such as has been described in detail herein above.

As shown in FIG. 6A, the support arms 628B includes only a single flat, substantially straight bar that can be pivotably coupled to the cover 628A of the cover assembly 628. During use of the generation assembly 610, the support arms 628B can be pivoted relative to the cover 628A such that the support arms 628B extend away from the cover 628A.

Additionally, as shown, the support arms 628B can be securely coupled to the back surface 614B of the solar panel assembly 614 with the coupler assembly 34. As illustrated in FIG. 6A, the coupler assembly 34 includes the first coupler member(s) 34A and the second coupler member 34B. In some embodiments, the first coupler member 34A can include a first magnet, e.g., a magnetic disc, that can be positioned and/or held within a magnetic cup that can be secured to each of the support arms 628B; and the second coupler member(s) 34B can include a second magnet, e.g., a magnetic or metal washer such as a soft steel washer, that can be secured to the back surface 614B of the solar panel assembly 614. The coupler members 34A, 34B should be positioned such that the coupler members 34A, 34B can effectively engage one another when the support arms 628B are positioned to extend away from the cover 628A during use of the generation assembly 610. Alternatively, the coupler assembly 34 can have a different design and/or the coupler members 34A, 34B can be designed to engage one another in a different manner.

As noted, the adjuster assembly 630 illustrated in FIGS. 6A-6D also has a different design than the previous embodiments. For example, as most clearly illustrated in FIG. 6B, the adjuster assembly 630 includes a brace member 630A that is coupled to and extends away from the cover 628A, and a serrated, rack member 630B that is coupled to the base 626A of the base assembly 626. As shown, the rack member 630B can include a plurality of slots that are adapted to receive a portion of the brace member 630A so that the adjuster assembly 630 can effectively position the cover 628A relative to the base 626A in a number of discrete positions. In some embodiments, the discrete slot positions can be labeled so that it is easy to direct the user to utilize the correct slot for the intended solar elevation angle.

As illustrated in FIG. 6C, when the solar panel assembly 614 is in the closed (folded) configuration, the solar panel assembly 614 can be of such size that the solar panel assembly 614 fits securely within the rigid case 616. With the solar panel assembly 614 so positioned within the rigid case 616, the case 616 can then be closed, i.e. moved to the storage configuration as shown in FIG. 6D. Additionally, in this embodiment, when the support assembly 616 is in the storage configuration, the cover 628A can be held closed by a mechanical clasp 648 that is hinged to the base 626A. The clasp 648 has a protruding ridge underneath it that is designed to fit into a mating trough in the cover 628A. Additionally, the clasp 648 can be designed to flex so that when the clasp 648 is closed on the cover 628A it exerts a clamping force down on the cover 628A. This securely closes the rigid case 616 and keeps the contents secure inside.

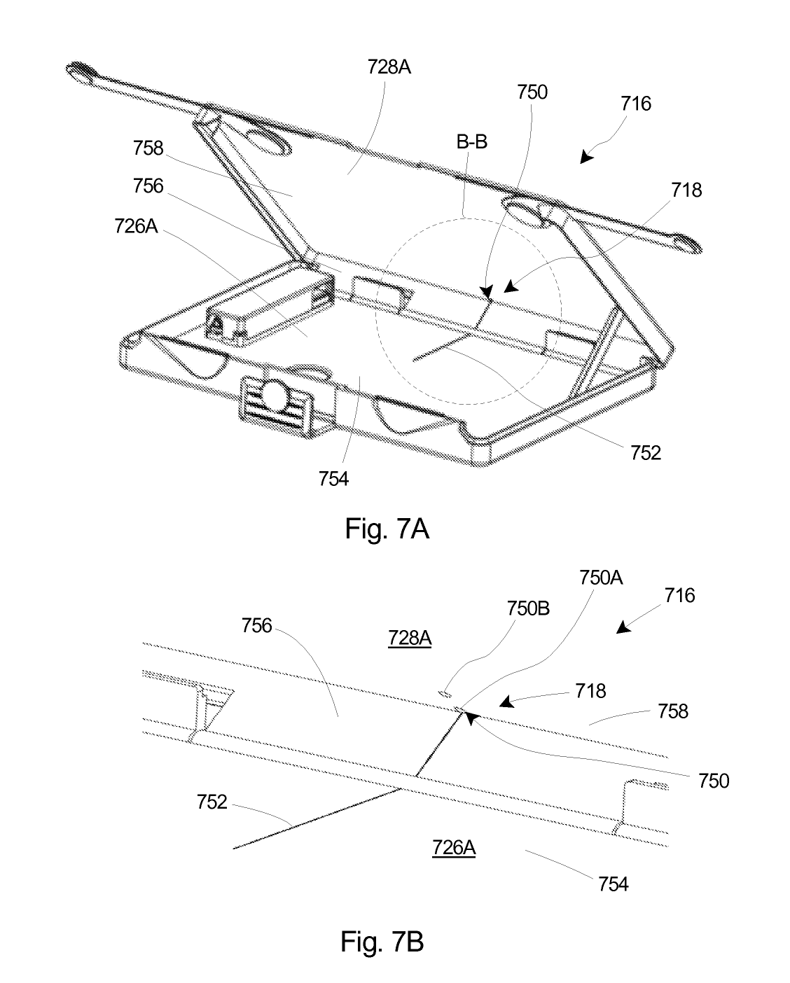

FIGS. 7A-7B, FIGS. 8A-8C and FIGS. 9A-9B illustrate certain representative embodiments of the positioning assembly that can be utilized to assist the user in ensuring that the solar panel assembly 14 (illustrated in FIG. 1A) is accurately positioned in terms of orientation and elevation for highly efficient collection of solar rays from the sun 11 (illustrated in FIG. 1A). As provided above, in various embodiments, the positioning assembly can include one or more signal-generating members that generate a signal that is based, at least in part, on the position of the sun 11 relative to the signal-generating member. Subsequently, the signal can be directed toward, received and/or interpreted by one or more signal-receiving members. More particularly, as noted above, the signal impinging on the signal-receiving member can be recognized as an indication to the user that the solar panel assembly 14 is accurately pointed toward the sun 11. By enabling optimal orientation of the solar panel assembly 14 toward the sun 11, the efficiency of the generation assembly 10 (illustrated in FIG. 1A) can be greatly improved.

FIG. 7A is a perspective view of an embodiment of the support and storage assembly 716 usable as part of the solar energy generation 10 assembly illustrated in FIG. 1A. In particular, as noted, FIG. 7A illustrates an embodiment of the positioning assembly 718 that can be utilized to ensure efficient collection of solar rays. Additionally, FIG. 7B is an enlarged view of a portion of the support and storage assembly 716, i.e. the positioning assembly 718, as indicated by dashed circle B-B in FIG. 7A.

As illustrated in this embodiment, the signal-generating member 750 includes one or more apertures that are formed, i.e. drilled, in the cover 728A of the support assembly 716. For example, as shown in FIGS. 7A and 7B, the positioning assembly 718 can include a first signal-generating member 750A, i.e. a first aperture, and a spaced apart second signal-generating member 750B, i.e. a second aperture. Additionally, in this embodiment, the signal-receiving member 752 includes one or more lines, or targets, that are formed onto an inner surface 754 of the base 726A and/or a rear cover wall 756 of the cover 728A.

During use, i.e. during positioning of the support assembly 716 to ensure efficient collection of solar rays, the positioning assembly 718 provides a sundial-like system that aids the user in accurately orienting the cover 728A (and, thus, the attached solar panel assembly 14 (illustrated in FIG. 1A)) so that the cover 728A is substantially perpendicular to the sun 11 (illustrated in FIG. 1A). More particularly, the sun 11 casts parallel rays of light that can shine through the apertures 750A, 750B such that a signal, e.g., a bright image of the sun 11, is cast on the inner surface 754 of the base 726A and/or along the rear cover wall 756 of the cover 728A. By adjusting the orientation and elevation of the cover 728A, the bright image of the sun 11 on the inner surface 754 of the base 726A can be moved so that the bright image coincides with and/or impinges on the signal-receiving member 752. At the position when the bright image coincides with and/or impinges on the signal-receiving member 752, the user can recognize that the solar panel assembly 14 is accurately pointed toward the sun 11.

In one embodiment, the first signal-generating member 750A on the cover 728A can be located tangent to the rear cover wall 756, which is constructed to be substantially perpendicular to a cover surface 758. In this manner, perpendicularity of the sun's beam through the aperture 750A to the cover 728A is visibly indicated when the cover 728A is tilted so that the sunbeam just touches, i.e. grazes, the rear cover wall 756, creating an illuminated thin line from the cover surface 758 down to a hinged connection between the cover 728A and the base 726A. The transition from a bright circular spot on the base 726A to an illuminated line on the rear cover wall 756 is very noticeable, and over-adjustment of the angle of the cover 728A relative to the base 726A is seen by the illumination line on the rear cover wall 756 growing wider and wider.

Additionally, in this embodiment, the second signal-generating member 750B can be spaced apart from the rear cover wall 756, such that the sun's beam shining through the aperture 750B can be seen as a bright circular spot on the base 726A. The storage assembly 716 can be moved and/or reoriented such that the bright circular spot impinges on the signal-receiving member 752, i.e. the line, along the inner surface 754 of the base 726A. Such impingement of the signal, i.e. the sun spot, indicates proper orientation of the storage assembly 716. The elevation, i.e. the angle of the cover 728A relative to the base 726A can then be adjusted such that, as noted above, the sun shining through the first signal-generating member 750A results in the sunbeam just touching the rear cover wall 756.

Alternatively, the positioning assembly 718 can have a different design, and/or the signal-generating members 750A, 750B and/or the signal-receiving member 752 can be positioned in a different manner. For example, in one non-exclusive alternative embodiment, an optics-folding arrangement can be utilized with the same basic method that diverts the sun's rays to the rear cover wall 756 instead of the inner surface 754 of the base 726A. Still alternatively, the positioning assembly 718 can be designed with more than two signal-generating members 750 or only one signal-generating member 750, i.e. without the first signal-generating member 750A or without the second signal-generating member 750B.

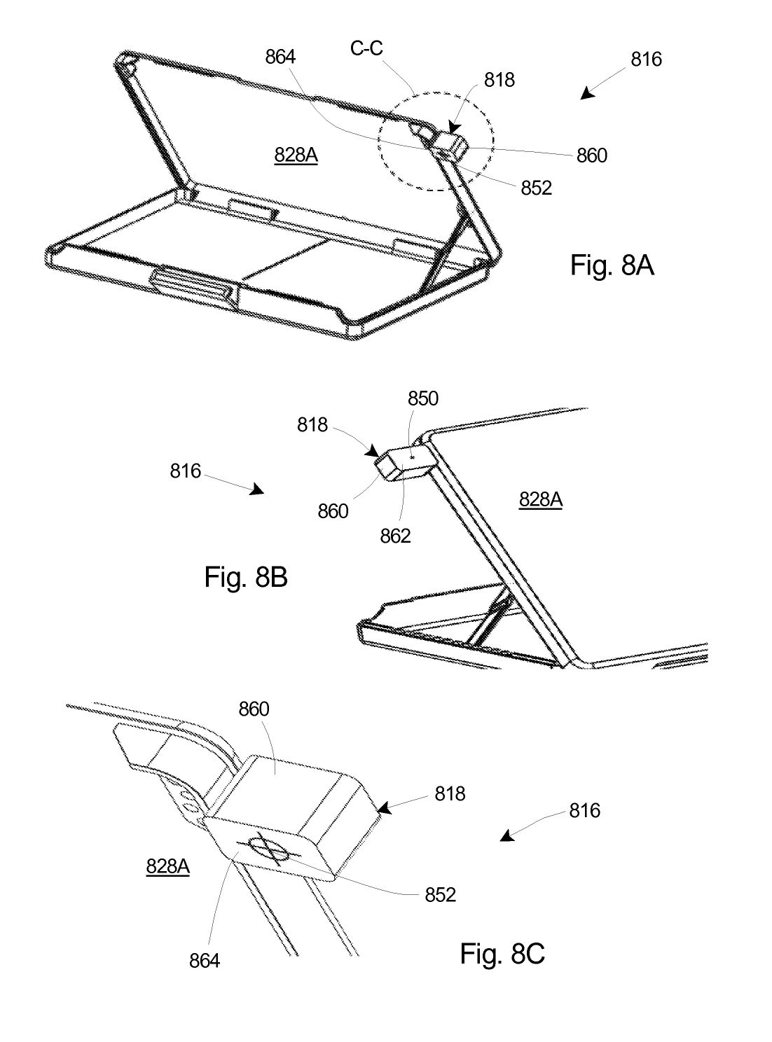

FIG. 8A is a perspective view of another embodiment of the support and storage assembly 816 usable as part of the solar energy generation assembly 10 illustrated in FIG. 1A. In particular, as noted, FIG. 8A illustrates another embodiment of the positioning assembly 818 that can be utilized to ensure efficient collection of solar rays. Additionally, FIG. 8B is another perspective view of the support and storage assembly 816 illustrated in FIG. 8A. Further, FIG. 8C is an enlarged view of a portion of the support and storage assembly 816, i.e. the positioning assembly 818, as indicated by dashed circle C-C in FIG. 8A.

In the embodiment illustrated in FIGS. 8A-8C, the positioning assembly 818 has a design that is somewhat similar to the design of the positioning assembly 718 illustrated and described above in relation to FIGS. 7A-7B. However, in this embodiment, the positioning assembly 818 includes a signal-generating member 850, i.e. an aperture, and a signal-receiving member 852, i.e. a line or target, that are encompassed within an assembly housing 860 that can be affixed to the cover 828A. In different embodiments, the positioning assembly 818 can be permanently affixed to the cover 828A or the positioning assembly 818 can be removably affixed to the cover 828A. Still alternatively, the positioning assembly 818 can be removably affixed to the solar panel assembly 14 (illustrated in FIG. 1A).

As illustrated, this embodiment of the positioning assembly 818 also provides a sundial-like system that aids the user in accurately orienting the cover 828A (and, thus, the attached solar panel assembly 14) so that the cover 828A is substantially perpendicular to the sun 11 (illustrated in FIG. 1A). In one embodiment, the assembly housing 860 is made of a transparent material. In this embodiment, a front surface 862 can include an opaque coating (e.g. black paint) with a transparent aperture 850 (coating removed). With this design, during positioning of the support assembly 816, the light of the sun 11 can shine through the aperture 850, thus generating a signal, i.e. a circle of light, that is directed generally toward a back surface 864 of the assembly housing 860. Stated in another fashion, the remainder of the front surface 862, i.e. other than the aperture 850, can be colored with a dark color such that light from the sun 11 is inhibited from shining through any portion of the front surface 862 other than the aperture 850.

The signal-receiving member 852, e.g., the target, can be formed on the back surface 864 of the assembly housing 860. In some embodiments, the back surface 864 can be roughened and/or otherwise frosted such that the light from the sun 11 is more clearly and precisely visible along the back surface 864. Additionally, portions of the assembly housing 860 other than the front surface 862 can have a degree of transparency that enables the user to see the light from the sun 11 along the back surface 864. During positioning and/or alignment of the support assembly 816, the position of the support assembly 816 can be adjusted such that the circle of light shining through the aperture 850 is directed precisely onto the target 852. In this manner, the user can be assisted in setting up the support assembly 816 to ensure that the collection of the solar rays can be achieved in a highly efficient manner.

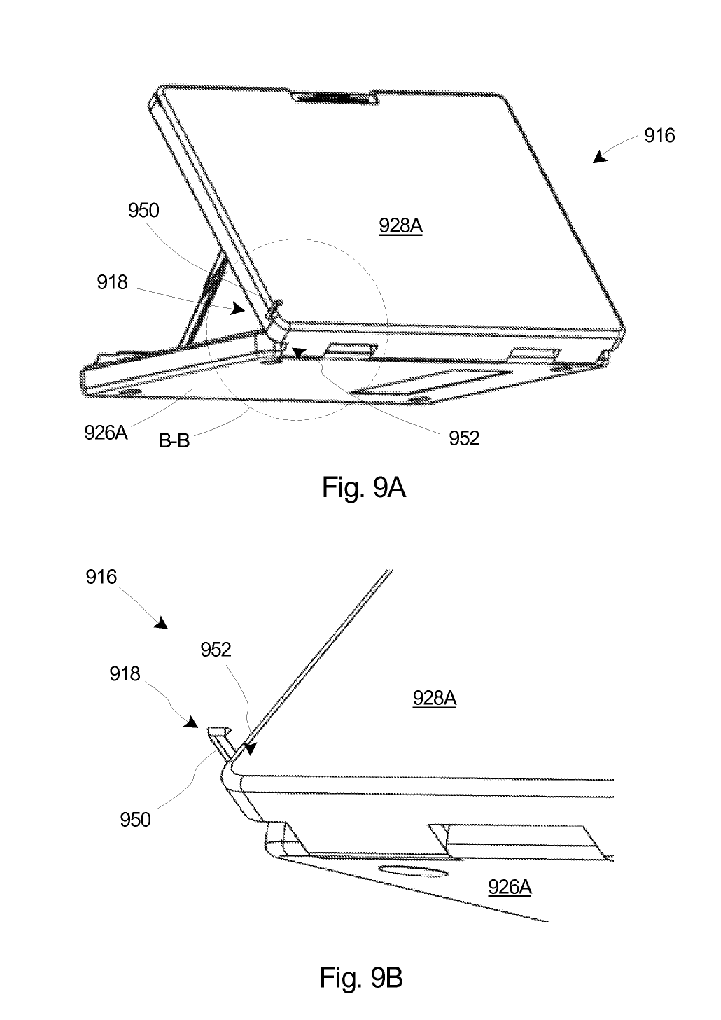

FIG. 9A is a perspective view of still another embodiment of a support and storage assembly 916 usable as part of the solar energy generation assembly 10 illustrated in FIG. 1A. In particular, as noted, FIG. 9A illustrates still another embodiment of the positioning assembly 918 that can be utilized to ensure efficient collection of solar rays. Additionally, FIG. 9B is an enlarged view of a portion of the support and storage assembly 916, i.e. the positioning assembly 918, as indicated by dashed circle B-B in FIG. 9A.

In this embodiment, the signal-generating member 950 takes the form of a mechanical post that is coupled to and extends away from the cover 928A like a sundial. When solar rays from the sun 11 (illustrated in FIG. 1A) hit the mechanical post 950, a signal is generated that is based on the position of the sun 11 relative to the mechanical post 950. More particularly, in this embodiment, the signal is in the form of a shadow that is cast generally downward toward and/or onto the signal-receiving member 952, e.g., the cover 928A of the support assembly 916. When the signal, i.e. the cast shadow, of the mechanical post is of proper length and position, perpendicularity to the sun 11 is indicated. More particularly, in certain embodiments, proper alignment is indicated by a thin, short shadow being formed on the cover 928A directly adjacent to the mechanical post 950, i.e. directly adjacent to the point where the mechanical post 950 is coupled to the cover 928A. Conversely, longer shadows created from the sun 11 hitting the mechanical post 950 and/or shadows being directed away from where the mechanical post 950 is coupled to the cover 928A are an indication that further adjustment of the position of the support assembly 916 is warranted. Additionally, the cover 928A can include one or more markings (not shown) that aid in determining the relative position.

It should be understood that these sundial ray-casting methods are easy for users to understand and utilize. Additionally, they are very robust and sufficiently accurate to orient the solar panel assembly 14 (illustrated in FIG. 1A) toward the sun 11 and lose less than 1% of the possible energy due to any potential misalignment of the solar panel assembly 14.

It is understood that although a number of different embodiments of the solar energy generation assembly 10 have been illustrated and described herein, one or more features of any one embodiment can be combined with one or more features of one or more of the other embodiments, provided that such combination satisfies the intent of the present invention.

While a number of exemplary aspects and embodiments of a solar energy generation assembly 10 have been shown and disclosed herein above for purposes of explanation, such exemplary aspects and embodiments are not intended to be exhaustive or to limit the invention in any manner. For example, those of skill in the art will recognize certain modifications, permutations, additions and sub-combinations thereof. It is therefore intended that the solar energy generation assembly 10 shall be interpreted to include all such modifications, permutations, additions and sub-combinations as are within their true spirit and scope, and no limitations are intended to the details of construction or design herein shown.

What is claimed is:

1. A solar panel assembly that is selectively positionable by a user to collect solar rays from a sun, the solar panel assembly comprising:
a first solar panel that is configured to collect solar rays from the sun;
a second solar panel that is configured to collect solar rays from the sun; and
a flexible, first connector that mechanically and electrically connects the first solar panel to the second solar panel so that the first solar panel and the second solar panel are selectively movable between an open configuration where the solar panels are positioned substantially side-by-side in a planar array and a closed configuration where the solar panels are stacked substantially on top of one another, the first connector including a perforated metal conductor that is coupled to and extends between the first solar panel and the second solar panel.

2. The solar panel assembly of claim 1 wherein the first connector includes a perforated copper mesh that is coupled to and extends between the first solar panel and the second solar panel.

3. The solar panel assembly of claim 1 further comprising a third solar panel that is configured to collect solar rays from the sun; and a flexible, second connector that mechanically and electrically connects the second solar panel to the third solar panel, the second connector including a perforated metal conductor that is coupled to and extends between the second solar panel and the third solar panel.

4. The solar panel assembly of claim 3 further comprising a fourth solar panel that is configured to collect solar rays from the sun; and a flexible, third connector that mechanically and electrically connects the third solar panel to the fourth solar panel, the third connector including a perforated metal conductor that is coupled to and extends between the third solar panel and the fourth solar panel.

5. A solar energy generation assembly including the solar panel assembly of claim 1, and a support assembly that supports the solar panel assembly during the collection of solar rays from the sun, the support assembly including a base and a cover that is adjustably coupled to the base.

6. The solar energy generation assembly of claim 5 further comprising a positioning assembly that is configured to assist the user in accurately pointing the solar panel assembly toward the sun, the positioning assembly including a signal-generating member that generates a signal based at least in part on the position of the sun relative to the signal-generating member.

7. The solar energy generation assembly of claim 5 wherein the support assembly is selectively movable between a storage configuration, wherein the solar panel assembly can be positioned substantially within the support assembly, and an operational configuration, wherein an angle of the cover relative to the base can be selectively adjusted to be between approximately zero and ninety degrees.

8. The solar energy generation assembly of claim 5 wherein the support assembly further includes a support arm that is movably coupled to the cover, and wherein the support arm can be removably coupled to the solar panel assembly with a coupler assembly when the support assembly is in the operational configuration.

9. The solar energy generation assembly of claim 8 wherein the coupler assembly includes a first coupler member that is secured to the support arm and a second coupler member that is secured to a back surface of the solar panel assembly, and wherein the coupler members are configured to selectively engage one another to removably couple the solar panel assembly to the cover.

10. The solar energy generation assembly of claim 9 wherein the first coupler member is a magnetic disc and wherein the second coupler member is a magnetic washer that selectively engages the magnetic disc.

11. The solar energy generation assembly of claim 5 further comprising a control assembly that controls the conversion of the solar rays that have been collected by the solar panel assembly into solar energy, the control assembly further controlling the use of the solar energy to provide power to a remote device.

12. The solar energy generation assembly of claim 11 wherein the control assembly further provides a first status update to the user relating to the conversion of the solar rays into solar energy, and a second status update to the user relating to the use of the solar energy to provide power to the remote device.

13. A solar energy generation assembly that is selectively positionable by a user relative to a sun to collect solar rays from the sun and generate solar energy from the solar rays, the solar energy generation assembly comprising:
a solar panel assembly that is configured to collect solar rays from the sun;
a support assembly that supports the solar panel assembly during the collection of solar rays from the sun; and
a positioning assembly that is configured to assist the user in accurately pointing the solar panel assembly toward the sun, the positioning assembly including a signal-generating member that generates a signal based at least in part on the position of the sun relative to the signal-generating member.

14. The solar energy generation assembly of claim 13 wherein the positioning assembly further includes a signal-receiving member, and wherein the signal impinging on the signal-receiving member indicates that the solar panel assembly is accurately pointed toward the sun.

15. The solar energy generation assembly of claim 14 wherein the positioning assembly further includes an assembly housing that is selectively coupled to the support assembly, wherein the signal-generating member is an aperture formed in a first surface of the assembly housing, and wherein the signal-receiving member is a target formed on a second surface of the assembly housing.

16. The solar energy generation assembly of claim 13 wherein the signal-generating member is an aperture formed in the support assembly.

17. The solar energy generation assembly of claim 13 wherein the signal-generating member is a mechanical protrusion that is coupled to and extends away from the support assembly.

18. The solar energy generation assembly of claim 13 wherein the solar panel assembly includes a first solar panel that is configured to collect solar rays from the sun; a second solar panel that is configured to collect solar rays from the sun; and a flexible, first connector that mechanically and electrically connects the first solar panel to the second solar panel, the first connector including a perforated metal conductor that is coupled to and extends between the first solar panel and the second solar panel.

19. The solar energy generation assembly of claim 13 wherein the support assembly includes a base and a cover that is adjustably coupled to the base; and wherein the support assembly is selectively movable between a storage configuration, wherein the solar panel assembly can be positioned substantially within the support assembly, and an operational configuration, wherein an angle of the cover relative to the base can be selectively adjusted to be between approximately zero and ninety degrees.

20. A solar energy generation assembly that is selectively positionable relative to a sun to collect solar rays from the sun and generate solar energy from the solar rays, the solar energy generation assembly comprising:
a solar panel assembly including a first solar panel, a second solar panel, a third solar panel and a fourth solar panel that are each configured to collect solar rays from the sun; and a connector assembly that mechanically and electrically connect the solar panels to one another so that the solar panel assembly is selectively movable between an open configuration where the solar panels are positioned substantially side-by-side in a planar array and a closed configuration where the solar panels are stacked substantially on top of one another, the connector assembly including a flexible, first connector having a first perforated metal conductor that is coupled to and extends between the first solar panel and the second solar panel, a flexible, second connector having a second perforated metal conductor that is coupled to and extends between the second solar panel and the third solar panel, and a flexible, third connector having a third perforated metal conductor that is coupled to and extends between the third solar panel and the fourth solar panel;
a support assembly that supports the solar panel assembly during the collection of solar rays from the sun, the support assembly including a base, a cover that is adjustably coupled to the base, and a support arm that is movably coupled to the cover; the support assembly being selectively movable between a storage configuration, wherein the solar panel assembly can be positioned substantially within the support assembly, and an operational configuration, wherein an angle of the cover relative to the base can be selectively adjusted to be between approximately zero and ninety degrees; the support arm being removably coupled to the solar panel assembly with a coupler assembly when the support assembly is in the operational configuration;
a positioning assembly that is configured to assist the user in accurately pointing the solar panel assembly toward the sun, the positioning assembly including a signal-generating member that generates a signal based at least in part on the position of the sun relative to the signal-generating member, and a signal-receiving member, wherein the signal impinging on the signal-receiving member indicates that the solar panel assembly is accurately pointed toward the sun; and
a control assembly that controls the conversion of the solar rays that have been collected by the solar panel assembly into solar energy, the control assembly further controlling the use of the solar energy to provide power to a remote device; and the control assembly providing a first status update to the user relating to the conversion of the solar rays into solar energy, and a second status update to the user relating to the use of the solar energy to provide power to the remote device.
